(19) United States
(12) Patent Application Publication
(10) Pub. No.: US 2019/0040664 A1
(43) Pub. Date: Feb. 7, 2019

(54) DOOR CHECK MECHANISM OF DOOR FOR VEHICLE

(71) Applicant: AISIN SEIKI KABUSHIKI KAISHA, Kariya-shi (JP)

(72) Inventors: Tomokazu SEKI, Kariya-shi (JP); Shintaro SUZUKI, Kariya-shi (JP); Hiroshi WATANABE, Kariya-shi (JP); Megumi ISHIDA, Kariya-shi (JP); Naohiro TAKAMI, Kariya-shi (JP); Masato YOSHIDA, Fukuoka-shi (JP)

(73) Assignee: AISIN SEIKI KABUSHIKI KAISHA, Kariya-shi (JP)

(21) Appl. No.: 15/538,740

(22) PCT Filed: Sep. 25, 2015
(86) PCT No.: PCT/JP2015/004884

§ 371 Date: Jun. 22, 2017

(30) Foreign Application Priority Data
Dec. 26, 2014 (JP) 2014-264314
Jul. 31, 2015 (JP) 2015-151872

(51) Int. Cl. E05C 17/20

(52) U.S. Cl. CPC E05C 17/203

(57) ABSTRACT

A door check mechanism includes a movement restricting member, a check link including one end portion which is configured to be rotatably mounted to a vehicle body, the check link being relatively movable relative to the movement restricting member in a longitudinal direction of the check link, a stopper portion provided at the other end portion of the check link, and an open degree adjustment block rotating relative to the check link and including a first contact portion and a second contact portion, the open degree adjustment block restricting a movement of the check link in a direction of the one end portion of the check link in a case where the open degree adjustment block rotates towards the check link so that the first contact portion makes contact with the movement restricting member and the stopper portion makes contact with the second contact portion.

### TECHNICAL FIELD

This invention relates to a door check mechanism of a door for a vehicle.

### BACKGROUND ART

A door for a vehicle is generally rotatably connected to a vehicle body via a door hinge at one side portion of the door. The door is configured to be retained at a predetermined open degree (open operation position) such as a full open degree and a partial open degree, for example, by a door check mechanism provided between the one side portion of the door and the vehicle body.

At this time, retaining the door open degree in a known door check mechanism, specifically, retaining the door at the partial open degree does not inhibit the door from opening beyond such open degree. Thus, in a case where a force in an open direction of the door is applied without a user's intention to the door that is held at the partial open degree, the known door check mechanism is not able to prevent the door from opening, which may result in the door that collides with an obstacle at a lateral side of the vehicle, for example.

Therefore, as disclosed in Patent document 1, a door check mechanism which fixes the open degree of the door is proposed, the door check mechanism including a check link to which a movement restraining force is applied by a fastening mechanism which includes holding pieces holding the check link so as to inhibit a movement of the check link.

### DOCUMENT OF PRIOR ART

### Patent Document

Patent document 1: JP2007-39981A

### Overview of Invention

### Problem to be Solved by Invention

The present invention provides a door check mechanism of a door for a vehicle which may restrict an open degree of the door and inhibit the door from opening to or beyond a restricted open degree.

### Means for Solving Problem

A door check mechanism according to one aspect of the present invention includes a movement restricting member configured to be mounted to a door for a vehicle, a check link including one end portion which is configured to be rotatably mounted to a vehicle body, the check link extending through an inner portion of the door for the vehicle and being relatively movable relative to the movement restricting member in a longitudinal direction of the check link, a stopper portion provided at the other end portion of the check link which extends through the inner portion of the door for the vehicle, and an open degree adjustment block rotating relative to the check link. The open degree adjustment block includes a first contact portion configured to make contact with the movement restricting member and a second contact portion opposed to the first contact portion while including a predetermined distance from the first contact portion, the second contact portion being configured to make contact with the stopper portion. The open degree adjustment block restricts a movement of the check link in a direction of the one end portion of the check link in a case where the open degree adjustment block rotates towards the check link so that the first contact portion makes contact with the movement restricting member and the stopper portion makes contact with the second contact portion.

A door check mechanism according to another aspect of the present invention includes, in addition to the aforementioned construction, another open degree adjustment block rotating relative to the check link. The another open degree adjustment block includes a third contact portion configured to make contact with the movement restricting member and a fourth contact portion opposed to the third contact portion while including a predetermined distance from the third contact portion, the fourth contact portion being configured to make contact with the stopper portion. A distance between the third contact portion and the fourth contact portion is longer than a distance between the first contact portion and the second contact portion. The another open degree adjustment block restricts the movement of the check link in the direction of the one end portion of the check link in a case where the another open degree adjustment block rotates towards the check link so that the third contact portion makes contact with the movement restricting member and the stopper portion makes contact with the fourth contact portion.

A door check mechanism according to still another aspect of the present invention includes, in addition to the aforementioned construction of the door check mechanism according to the one aspect, another open degree adjustment block moving relative to the check link. The another open degree adjustment block includes a third contact portion configured to make contact with the second contact portion and a fourth contact portion opposed to the third contact portion while including a predetermined distance from the third contact portion, the fourth contact portion being configured to make contact with the stopper portion. The open degree adjustment block and the another open degree adjustment block restrict the movement of the check link in the direction of the one end portion of the check link in a case where the another open degree adjustment block moves towards the check link so that the third contact portion makes contact with the second contact portion and the stopper portion makes contact with the fourth contact portion.

The open degree adjustment apparatus of the door for the vehicle according to the one aspect of the present invention is an open degree adjustment apparatus which adjusts an open degree of the door for the vehicle employed in a door check mechanism including a movement restricting member configured to be mounted to a door for a vehicle, a check link including one end portion which is configured to be rotatably mounted to a vehicle body, the check link extending through an inner portion of the door for the vehicle and being relatively movable relative to the movement restricting member in a longitudinal direction of the check link, and a stopper portion provided at the other end portion of the check link which extends through the inner portion of the door for the vehicle. The open degree adjustment apparatus includes an open degree adjustment block rotating relative to the check link and the movement restricting member, the open degree adjustment block including a first contact portion configured to make contact with the movement restricting member and a second contact portion opposed to the first contact portion while including a predetermined distance from the first contact portion, the second contact portion being configured to make contact with the stopper portion. The open degree adjustment block restricts a movement of the check link in a direction of the one end portion of the check link in a case where the open degree adjustment block rotates towards the check link so that the first contact portion makes contact with the movement restricting member and the stopper portion makes contact with the second contact portion.

According to the aforementioned construction, the door check mechanism according to the present invention may restrict the open degree of the door and inhibit the door from opening to or beyond a restricted open degree.

Further characteristics of the present invention are clarified through explanation of the following embodiments disclosed as examples with reference to the attached drawings.

### BRIEF DESCRIPTION OF DRAWINGS

FIG. 1 illustrates a vehicle including a door check mechanism according to a first embodiment;

FIG. 2A illustrates the door check mechanism according to the first embodiment;

FIG. 2B illustrates a door check in the door check mechanism according to the first embodiment;

FIG. 2C illustrates an open degree adjustment block in the door check mechanism according to the first embodiment;

FIG. 3 explains an operation of the door check;

FIG. 4A illustrates an operation of the door check mechanism according to the first embodiment;

FIG. 4B illustrates the operation of the door check mechanism according to the first embodiment;

FIG. 4C illustrates the operation of the door check mechanism according to the first embodiment;

FIG. 5A illustrates a case portion of the door check;

FIG. 5B illustrates a base portion of the door check;

FIG. 6 illustrates the door check mechanism according to a modified example of the first embodiment;

FIG. 7 illustrates the door check mechanism according to another modified example of the first embodiment;

FIG. 8 illustrates the door check mechanism according to a second embodiment;

FIG. 9A illustrates the operation of the door check according to the second embodiment;

FIG. 9B illustrates the operation of the door check according to the second embodiment;

FIG. 10 illustrates the door check mechanism according to a third embodiment;

FIG. 11 illustrates the door check mechanism according to a fourth embodiment;

FIG. 12A illustrates the operation of the door check mechanism according to the fourth embodiment;

FIG. 12B illustrates the operation of the door check mechanism according to the fourth embodiment;

FIG. 12C illustrates the operation of the door check mechanism according to the fourth embodiment;

FIG. 13 illustrates the door check mechanism according to a fifth embodiment;

FIG. 14 illustrates the open degree adjustment block and a block base in the door check mechanism according to the fifth embodiment;

FIG. 15 illustrates the door check mechanism according to the fifth embodiment;

FIG. 16 illustrates the door check mechanism according to a modified example of the fifth embodiment;

FIG. 17 illustrates the door check mechanism according to a sixth embodiment;

FIG. 18A illustrates the operation of the door check mechanism according to the sixth embodiment;

FIG. 18B illustrates the operation of the door check mechanism according to the sixth embodiment;

FIG. 18C illustrates the operation of the door check mechanism according to the sixth embodiment;

FIG. 19 illustrates the door check mechanism according to a seventh embodiment;

FIG. 20A illustrates the operation of the door check mechanism according to the seventh embodiment;

FIG. 20B illustrates the operation of the door check mechanism according to the seventh embodiment;

FIG. 20C illustrates the operation of the door check mechanism according to the seventh embodiment;

FIG. 21 illustrates the door check mechanism according to an eighth embodiment;

FIG. 22A illustrates the operation of the door check mechanism according to the eighth embodiment;

FIG. 22B illustrates the operation of the door check mechanism according to the eighth embodiment; and

FIG. 22C illustrates the operation of the door check mechanism according to the eighth embodiment.

### MODE FOR CARRYING OUT THE INVENTION

Embodiments of the present invention are explained in detail below with reference to the attached drawings. At this time, dimensions, materials, configurations and relative positions between components, for example, explained in the following embodiments are arbitrarily specified and are changeable depending on a construction of an apparatus where the present invention is employed or on various conditions. In addition, the same reference numerals are utilized among the drawings for indicating the same or functionally similar components. In the description, an upper direction and a lower direction correspond to those in a gravity direction. Further, in the description, an apparatus utilized at a door check mechanism for restricting an open degree of a door D by including a movement restricting member such as a door check, for example, and an open degree adjustment block is referred to as an open degree adjustment apparatus.

### First Embodiment

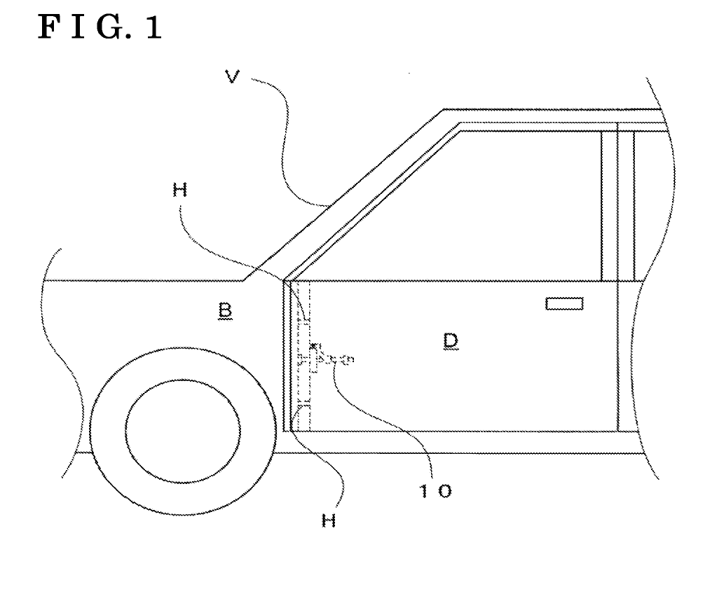

A door check mechanism 10 according to a first embodiment of the present invention is explained with reference to FIGS. 1, 2, 3, 4, 5A and 5B. FIG. 1 is a schematic side view illustrating a vehicle V which includes the door check mechanism 10 according to the present embodiment.

In the vehicle V, the door D is rotatably connected to a vehicle body B via a hinge H. The door check mechanism 10 is disposed between the door D and the vehicle body B.

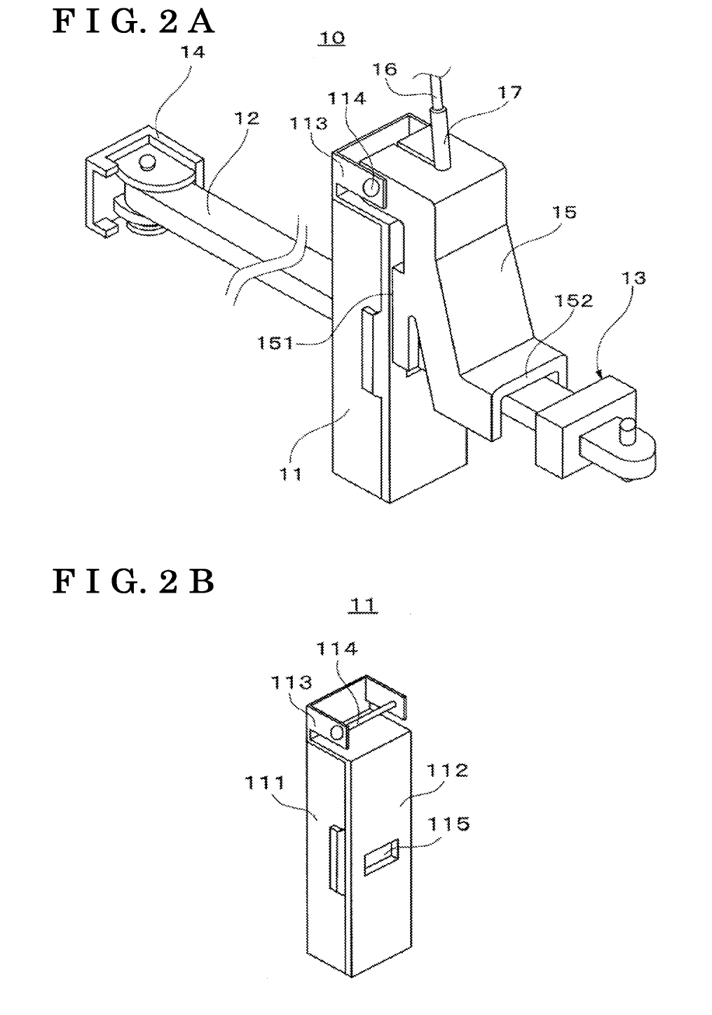

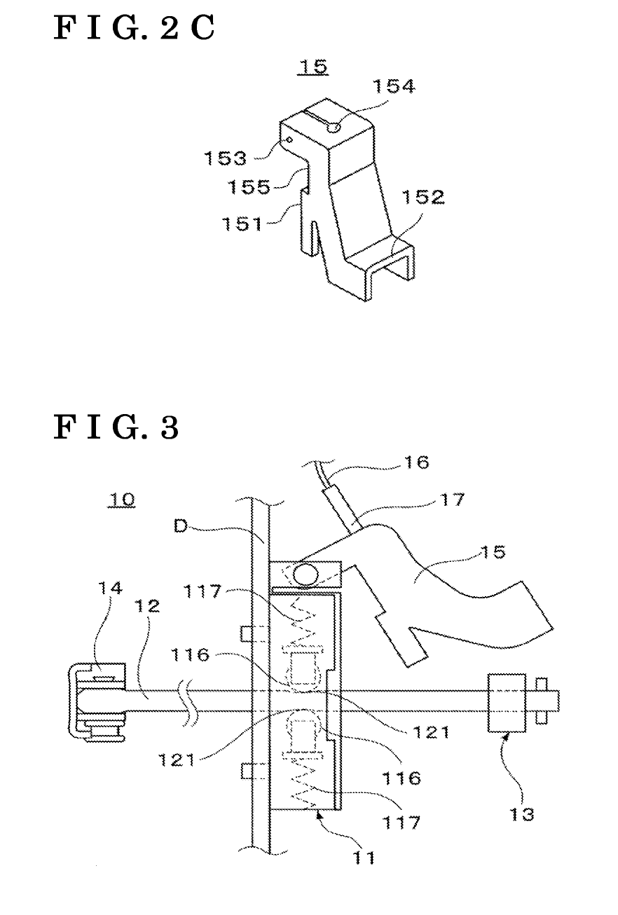

FIG. 2A illustrates the door check mechanism 10 according to the present embodiment. In FIG. 2A, illustrations of the vehicle body B and the door D are omitted for the purpose of simple explanation. The door check mechanism 10 includes a door check 11, a check link 12, a stopper portion 13, a bracket 14 and an open degree adjustment block 15. The open degree adjustment block 15 is connected to an operation portion which is not illustrated, via a connection member 16 and is biased in a predetermined direction by a biasing member 17.

FIG. 2B illustrates the door check 11 (movement restricting member). The door check 11 includes a case portion 111 and a base portion 112. As illustrated in FIG. 1, the door check 11 is mounted to the door D. The check link 12 is arranged to extend through an inner portion of the door D by passing through an inner portion of the door check 11 via an open portion 115 of the door check 11. In FIG. 2B, only the open portion 115 at the base portion 112 is illustrated; however, the same open portion serving as the open portion 115 is also provided at the case portion 111 so that the check link 12 passes through the inner portion of the door check 11 via the aforementioned open portions 115. Each bearing portion 113 supporting a rotary shaft 114 for the open degree adjustment block 15 is provided at a top portion of the base portion 112 of the door check 11.

As illustrated in FIG. 2A, one end portion of the check link 12 is rotatably mounted to the vehicle body B via the bracket 14 which is coupled to the vehicle body B. The check link 12 extends through the inner portion of the door D by passing through the door check 11. The stopper portion 13 is provided at the other end portion of the check link 12 which extends through the inner portion of the door D.

The check link 12 rotates relative to the vehicle body B with the rotation of the door D. In a case where the door D is opened or closed, the door D moves in a direction separating from the vehicle body B or approaching the vehicle body B based on the rotation of the door D. Therefore, the check link 12 mounted to the vehicle body B rotates on a basis of the rotation of the door D and is pulled out from the inner portion of the door D which moves in the direction separating from the vehicle body B when the door D is opened. In a case where the door D is closed, the check link 12 is inserted to the inner portion of the door D which moves in the direction approaching the vehicle body B. Accordingly, in a case where the door D rotates, the check link 12 is relatively movable in a longitudinal direction of the check link 12 relative to the door check 11 that is mounted to the door D.

In a case where the door D is opened, the check link 12 is pulled out from the door D with the rotation of the door D to move relative to the door check 11 in a direction of the one end portion of the check link 12 via which the check link 12 is mounted to the vehicle body B. Because of the movement of the check link 12 in the direction of the one end portion of the check link 12 mounted to the vehicle body B, the stopper portion 13 moves towards the door check 11. In a case where the stopper portion 13 makes contact with the door check 11, the check link 12 is restricted from moving in the direction of the aforementioned one end portion and is inhibited from being pulled out from the door D any more. When the movement of the check link 12, i.e., the rotation thereof, is restricted, the rotation of the door D is also restricted. Thus, the open degree of the door D is restricted on a basis of the restriction of the movement of the check link 12. The open degree of the door D in a case where the stopper portion 13 makes contact with the door check 11 serves as a full open degree of the door D.

As illustrated in FIGS. 2A and 2C, the open degree adjustment block 15 includes a first contact portion 151 configured to make contact with the door check 11, a second contact portion 152 configured to make contact with the stopper portion 13, a bore portion 153 through which the rotary shaft 114 passes to be positioned, a bore portion 154 through which the connection member 16 passes to be positioned and a cut portion 155. The second contact portion 152 is arranged being opposed to the first contact portion 151 while including a predetermined distance from the first contact portion 151. The cut portion 155 is obtained by cutting the first contact portion 151 by a predetermined length, in the vicinity of the rotary shaft 114 and the bore portion 153 through which the rotary shaft 114 penetrates to be positioned.

The open degree adjustment block 15 is mounted to the door check 11 so as to be rotatable about the rotary shaft 114 in a state where the rotary shaft 114 which is provided at the door check 11 passes through the bore portion 153 to be positioned therein. Accordingly, the open degree adjustment block 15 is rotatable relative to the door check 11 and the check link 12. As illustrated in FIG. 2A, the first contact portion 151 provided at the open degree adjustment block 15 makes contact with the door check 11 in a case where the open degree adjustment block 15 rotates towards a position abutting the check link 12. At this time, because the second contact portion 152 is provided being opposed to the first contact portion 151 as mentioned above, the second contact portion 152 faces the stopper portion 13 which is configured to make contact with the door check 11. Therefore, the check link 12 moves in the direction of the one end portion thereof mounted to the vehicle body B so that the stopper portion 13 makes contact with the second contact portion 152.

The open degree adjustment block 15 is connected to the operation portion which is not illustrated, via the arbitrary connection member 16 including a wire, a cable and a bar-formed member (a rod), for example. The open degree adjustment block 15 rotates about the rotary shaft 114 on a basis of an operation of the operation portion by a user. The operation portion may be a handle, a lever, a switch or a dial mounted at the door D or a switch mounted at a portable device, for example. The movement of the connection member 16 may be based on a movement of the lever or an operation of an actuator connected to the switch, for example. The switch mentioned here is not limited to a mechanical button and may be a switch displayed at a touch panel display, for example.

The open degree adjustment block 15 is biased by the biasing member 17 including a spring or a rubber member, for example, in a direction towards the position abutting the check link 12. Thus, in a case where an external force is not applied to the open degree adjustment block 15 by the connection member 16, the open degree adjustment block 15 is arranged at a position between the door check 11 and the stopper portion 13, i.e., at the position abutting the check link 12.

Next, retention of the open degree of the door D by the door check 11 and the check link 12 is explained with reference to FIG. 3. FIG. 3 is a perspective view illustrating the door check mechanism 10. In FIG. 3, the illustration of the vehicle body B is omitted for the purpose of simple explanation.

In order to retain the open degree of the door D at a predetermined open degree, pressing elements 116 and biasing members 117 are provided at the inner portion of the door check 11. In addition, groove portions 121 are provided at an upper surface and a bottom surface of the check link 12. The pressing elements 116 are biased by the respective biasing members 117 each of which includes a spring or a rubber member, for example, towards the check link 12 which passes through the inside of the door check 11. The pressing elements 116 are supported to be rollable in the longitudinal direction of the check link 12. Therefore, in a case where the check link 12 moves in the direction of the one end portion thereof mounted to the vehicle body B in accordance with the rotation of the door D, the pressing elements 116 are rollable along the upper surface and the bottom surface of the check link 12. At this time, each of the pressing elements 116 rolls along the check link 12 based on the rotation of the door D and fits in the groove portion 121 provided at a predetermined position of the check link 12. As a result, the movement of the check link 12 may be simply restricted. The door check 11 and the check link 12 may hold and retain the open degree of the door D at the predetermined open degree depending on the position where the groove portion 121 is provided.

The aforementioned retention of the open degree of the door D by the door check 11 and the check link 12 is a tentative retention and is releasable by an application of a force to the door D to the extent that the pressing element 116 disengages from the groove portion 121. Therefore, the aforementioned retention of the open degree of the door D by the door check 11 and the check link 12 may be released by unintentional application of the force to the door D in a direction where the door D is opened. The door D may thus collide with an obstacle, for example, at a lateral side of the vehicle V. Thus, according to the door check mechanism 10 of the present embodiment, the open degree of the door D is restricted so as to inhibit the aforementioned collision of the door D against the obstacle, for example, by the open degree adjustment block 15 disposed at the position being sandwiched between the door check 11 and the stopper portion 13 provided at the check link 12.

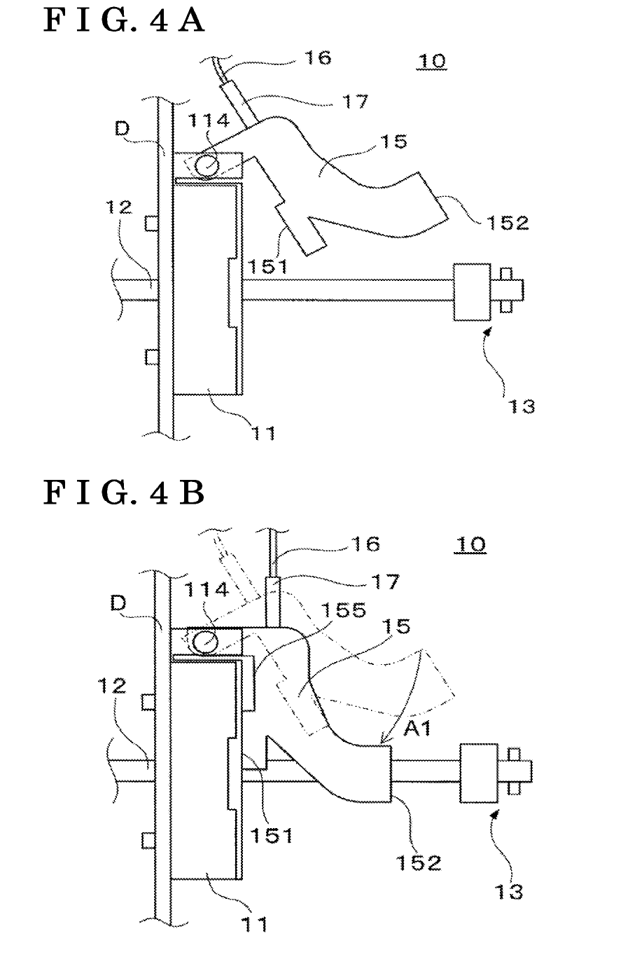

The restriction of the open degree of the door D with the usage of the open degree adjustment block 15 is explained with reference to FIGS. 4A, 4B and 4C. FIGS. 4A to 4C are side views each of which illustrates the door check mechanism 10 according to the present embodiment. FIG. 4A illustrates the door check mechanism 10 in a case where the open degree adjustment block 15 is arranged at a position at which the open degree of the door D is not restricted. FIG. 4B explains the rotation of the open degree adjustment block 15. FIG. 4C explains the restriction of the movement of the check link 12 by the open degree adjustment block 15. In FIG. 4B, the open degree adjustment block 15 illustrated in FIG. 4A is indicated by an alternate long and two short dashes line. In FIGS. 4A to 4C, the illustrations of the vehicle body B and the bracket 14 are omitted for the purpose of simple explanation.

In a case where the open degree of the door D is not restricted by the user and the open degree of the door D is specified so that the door D is rotatable to the full open degree, the open degree adjustment block 15 is rotated to the upper side about the rotary shaft 114 relative to the check link 12 as illustrated in FIG. 4A. In this case, the first contact portion 151 is inhibited from making contact with the door check 11 and the second contact portion 152 is also inhibited from making contact with the stopper portion 13. In a case where the check link 12 moves with the open operation of the door D, the stopper portion 13 is inhibited from making contact with the open degree adjustment block 15 and makes contact with the door check 11 by moving in the direction of the one end portion of the check link 12 mounted to the vehicle body B. As a result, the door D is rotatable to the full open degree.

Next, in a case where the user operates the operation portion not illustrated so as to restrict the open degree of the door D, the open degree adjustment block 15 rotates in a direction indicated by an arrow A1 (downward direction) as illustrated in FIG. 4B from the position indicated by the alternate long and two short dashes line serving as the position in FIG. 4A. When the open degree adjustment block 15 rotates towards the position abutting the check link 12 along the arrow A1, the first contact portion 151 makes contact with the door check 11. In a case where the first contact portion 151 rotates to the position contacting the door check 11, the open degree adjustment block 15 becomes adjacent to the check link 12 as illustrated in FIG. 4B. At this time, because the first contact portion 151 makes contact with the door check 11, the second contact portion 152 which is opposed to the first contact portion 151 faces the stopper portion 13 facing the door check 11.

As illustrated in FIG. 4B, the open degree adjustment block 15 includes the cut portion 155 in the vicinity of the rotary shaft 114 of the open degree adjustment block 15. The cut portion 155 is obtained by cutting the first contact portion 151 by the predetermined length in the longitudinal direction of the check link 12. As a result, a load generated in a case where the first contact portion 151 makes contact with the door check 11 by the rotation of the open degree adjustment block 15 to the position abutting the check link 12 is avoidable from being concentrated in a portion of the first contact portion 151 in the vicinity of the rotary shaft 114.

When the door D is opened after the open degree adjustment block 15 rotates to the position illustrated in FIG. 4B, the check link 12 moves in the direction of the one end portion thereof mounted to the vehicle body B, which causes the stopper portion 13 to move. At this time, because the open degree adjustment block 15 is arranged so that the second contact portion 152 faces the stopper portion 13 as mentioned above, the stopper portion 13 makes contact with the second contact portion 152 based on the movement of the stopper portion 13 as illustrated in FIG. 4C. The open degree adjustment block 15 is in contact with the door check 11 at the first contact portion 151, which restricts the check link 12 from moving in the direction of the one end thereof mounted to the vehicle body B. Accordingly, the open degree adjustment block 15 is sandwiched between the door check 11 and the stopper portion 13 to restrict the movement of the stopper portion 13, i.e., the movements of the stopper portion 13 and the check link 12 in the direction of the one end portion of the check link 12 mounted to the vehicle body B. The rotation of the door D in the open direction is thus restricted with the restriction of the movement of the check link 12. The open degree of the door D may be restricted by the open degree adjustment block 15 rotating to be arranged between the door check 11 and the stopper portion 13.

As mentioned above, the door check mechanism 10 according to the present embodiment includes the door check 11 configured to be mounted to the door D for the vehicle, the check link 12 configured so that the one end portion is rotatably mounted to the vehicle body B, the check link 12 extending through the inner portion of the door D for the vehicle, and the stopper portion 13 provided at the other end portion of the check link 12 which extends through the inner portion of the door D for the vehicle. The check link 12 is relatively movable in the longitudinal direction of the check link 12 relative to the door check 11 based on the rotation of the door D. The door check mechanism 10 further includes the open degree adjustment block 15 which rotates relative to the check link 12. The open degree adjustment block 15 includes the first contact portion 151 configured to make contact with the door check 11 and the second contact portion 152 opposed to the first contact portion 151 while including the predetermined distance from the first contact portion 151 and configured to make contact with the stopper portion 13. In a case where the open degree adjustment block 15 rotates towards the check link 12 so that the first contact portion 151 makes contact with the door check 11, the open degree adjustment block 15 is restricted from moving in the direction of the one end portion of the check link 12 mounted to the vehicle body B. In a case where the open degree adjustment block 15 is restricted from moving in the direction of the one end portion of the check link 12 and the stopper portion 13 makes contact with the second contact portion 152, the open degree adjustment block 15 restricts the check link 12 from moving in the direction of the one end portion thereof.

The check link 12 is restricted from moving in the direction of the one end portion thereof mounted to the vehicle body B by the open degree adjustment block 15. Thus, even in a case where an external force is unintentionally applied to the door D in the open operation direction thereof, the door D is inhibited from opening. In the restriction of the open degree of the door D, the door D is only restricted from rotating in the open direction from the open degree at which the open degree of the door D is restricted. Thus, the door D is rotatable within a range from the aforementioned open degree to a full close position. In addition, because the open degree adjustment block 15 moves to the position between the door check 11 and the stopper portion 13 by rotating, a positioning error of the open degree adjustment block 15 relative to the door check 11 and the stopper portion 13, for example, may be inhibited.

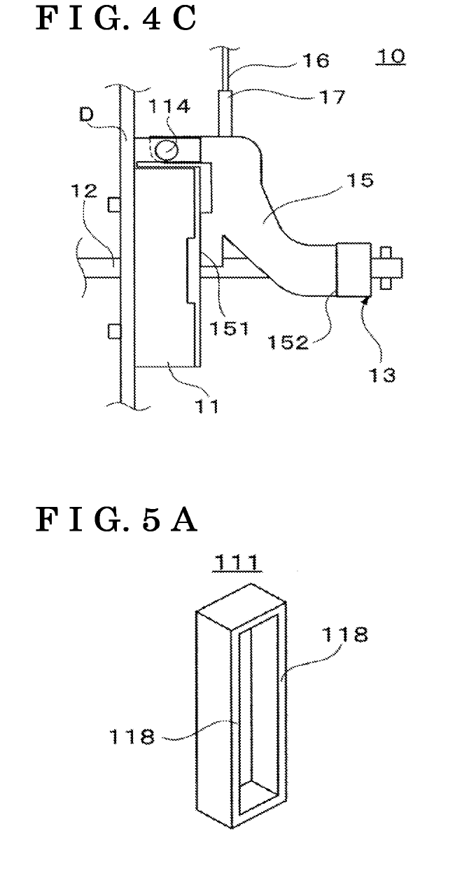

In addition, according to the door check mechanism 10 of the present embodiment, in order to restrain deformation of the door check 11 caused by a load transmitted from the stopper portion 13 via the open degree adjustment block 15, the first contact portion 151 makes contact with a solid portion of the door check 11. Such construction is explained with reference to FIGS. 5A and 5B. FIG. 5A illustrates the case portion 111 of the door check 11 and FIG. 5B illustrates the base portion 112 of the door check 11. In FIG. 5A, the case portion 111 includes a frame portion 118. In FIG. 5B, the base portion 112 includes a frame portion abutting portion 119 (a region surrounded by an alternate long and two short dashes line) conforming to the frame portion 118. The region of the frame portion abutting portion 119 is an example and the frame portion abutting portion 119 may be a portion abutting the frame portion 118 of the case portion 111 in a case where the case portion 111 and the base portion 112 are assembled on each other.

As illustrated in FIG. 3, the door check 11 includes at the inner portion thereof the pressing elements 116 and the biasing members 117. Thus, the door check 11 is configured by the case portion 111 and the base portion 112 as illustrated in FIGS. 5A and 5B so as to include a hollow portion. In a case where the first contact portion of the open degree adjustment block 15 makes contact with the hollow portion of the door check 11 when contacting the door check 11, the load transmitted from the stopper portion 13 upon restriction of the open degree of the door D is transmitted to the hollow portion via the open degree adjustment block. Thus, the portion of the door check 11 with which the first contact portion of the open degree adjustment block makes contact may be deformed by the load transmitted to the portion of the door check 11 as mentioned above, which may lead to distortion or dent of the door check 11.

In light of the above, according to the door check mechanism 10 of the present embodiment, in order to restrain the deformation of the door check 11 resulting from the aforementioned load, the first contact portion 151 makes contact with the solid portion of the door check 11, i.e., the frame portion abutting portion 119 of the base portion 112 conforming to the frame portion 118 of the case portion 111. That is, the first contact portion 151 makes contact with the solid portion of the door check 11 including a predetermined thickness in the longitudinal direction of the check link 12. In this case, because the load transmitted from the stopper portion 13 upon restriction of the open degree of the door D is transmitted to the frame portion (solid portion) 118 of the door check 11 via the open degree adjustment block 15, the deformation of the door check 11 may be restrained. The solid portion of the door check 11 is not limited to the frame portion abutting portion 119 of the base portion 112 conforming to the frame portion 118 of the case portion 111. For example, in order to improve rigidity of the door check 11, the solid portion of the door check 11 may be a thick portion, for example, provided at the case portion 111 or the base portion 112. The configurations of the first contact portion 151 and the second contact portion 152 of the open degree adjustment block 15 may be arbitrarily specified as long as the first contact portion 151 and the second contact portion 152 are contactable to the door check 11 and the stopper portion 13 respectively. Therefore, the open degree adjustment block may be configured so that only a portion of the first contact portion makes contact with the solid portion of the door check 11. Even in this case, the load from the stopper portion 13 is transmitted to the solid portion of the door check 11 by the aforementioned portion of the first contact portion which makes contact with the solid portion. Accordingly, even in a case where only the portion of the first contact portion makes contact with the solid portion of the door check 11, the deformation of the door check 11 based on the load transmitted from the stopper portion 13 via the open degree adjustment block is restrained.

In the door check mechanism 10 of the present embodiment, the rotary shaft 114 of the open degree adjustment block 15 is provided at a top portion of the door check 11. At this time, the position and the direction of the rotary shaft 114 are not limited to the above. The rotary shaft of the open degree adjustment block may be provided so that the open degree adjustment block is movable to the position between the door check 11 and the stopper portion 13, i.e., to the position abutting the check link 12, by the rotation of the open degree adjustment block.

Therefore, the rotary shaft of the open degree adjustment block may be provided at an arbitrary position of the door check 11. In addition, the direction of the rotary shaft may be specified depending on the position at which the rotary shaft is provided, so that the open degree adjustment block is movable to the position abutting the check link 12 by the rotation of the open degree adjustment block. Accordingly, the rotary shaft of the open degree adjustment block may be provided at a bottom portion of the door check 11, for example, and the direction of the rotary shaft may be specified so that the open degree adjustment block rotates in the upper direction towards the check link 12 from the lower side of the door check 11. In the same manner, the rotary shaft of the open degree adjustment block may be provided at a lateral portion of the door check 11 and the direction of the rotary shaft may be specified so that the open degree adjustment block rotates towards the check link 12 from the lateral side of the door check 11. In a case where the rotary shaft of the open degree adjustment block is provided extending in a width direction of the door D at either one of the top portion and the bottom portion of the door check 11, the open degree adjustment block is inhibited from rotating in the width direction of the door D. In this case, the width of the door D corresponds to a distance between an outer surface constituted by an outer panel of the door D and an inner surface constituted by an inner panel of the door D. The width direction corresponds to the direction of the aforementioned width. Thus, increase in width dimension of the door D resulting from providing the open degree adjustment block is restrained. In addition, the increase in width dimension of the door D may be further restrained in a state where the length of the rotary shaft of the open degree adjustment block and the width dimension of the open degree adjustment block in the extending direction of the rotary shaft are substantially equalized with or smaller than the width dimension of the door check 11 in the extending direction of the rotary shaft.

In the door check 11 of the present embodiment, the rotary shaft 114 of the open degree adjustment block 15 is provided at the base portion 112 of the door check 11. At this time, the member at which the rotary shaft of the open degree adjustment block is provided is not limited to the base portion 112. For example, the rotary shaft of the open degree adjustment block may be provided at the case portion 111 of the door check 11. In addition, the rotary shaft of the open degree adjustment block may be provided at a separate member mounted to the door check 11 or a separate member mounted to the door D. The separate member mounted to the door D may be a member disposed between the door check 11 and the door D in a case where the door check 11 is mounted to the door D or a member mounted to the door D independently from the door check 11. Even in a case where the rotary shaft of the open degree adjustment block is provided at the separate member from the door check 11, the rotary shaft of the open degree adjustment block may be provided so that the open degree adjustment block is rotatable to the position between the door check 11 and the stopper portion 13. That is, as long as the open degree adjustment block rotates and moves to the position between the door check 11 and the stopper potion 13, the open degree adjustment block may be disposed between the door check 11 and the stopper portion 13 when the door D is opened to thereby restrict the open degree of the door D. Thus, the direction of the rotary shaft of the open degree adjustment block may be specified so that the open degree adjustment block rotates to the position between the door check 11 and the stopper portion 13 based on the member at which the rotary shaft of the open degree adjustment block is provided and the position thereof.

At this time, the position and the direction of the rotary shaft of the open degree adjustment block may be specified so that the first contact portion of the open degree adjustment block makes contact with the door check 11 in the rotation direction of the open degree adjustment block. For example, the position and the direction of the rotary shaft of the open degree adjustment block may be specified so that the open degree adjustment block rotates from the vicinity of the door check 11 such as the upper side, the lower side and the lateral side thereof, to the position at which the first contact portion makes contact with the door check 11. In this case, the first contact portion makes contact with the door check 11 to thereby restrict the rotation of the open degree adjustment block. The open degree adjustment block is arranged at the position between the door check 11 and the stopper portion 13, i.e., at the position abutting the check link 12. Because the first contact portion makes contact with the door check 11 to restrict the rotation of the open degree adjustment block, the positioning error of the open degree adjustment block, for example, when the open degree adjustment block moves to the position abutting the check link 12, may be inhibited.

In the aforementioned construction, the rotary shaft 114 of the open degree adjustment block 15 according to the present embodiment is provided at the top portion of the door check 11 as illustrated in FIGS. 4A, 4B and 4C. The direction of the rotary shaft 114 of the open degree adjustment block 15 is specified so that the open degree adjustment block 15 is restricted from rotating by the contact of the first contact portion 151 with the door check 11 in a case where the open degree adjustment block 15 rotates to the position abutting the check link 12. Because the rotation of the open degree adjustment block 15 is restricted by the first contact portion 151 contacting the door check 11, the positioning error of the open degree adjustment block 15, for example, when the open degree adjustment block 15 moves to the position abutting the check link 12 may be inhibited. In addition, the open degree adjustment block 15 rotates in an up-down direction about the rotary shaft 114 which extends in the width direction of the door D and thus is inhibited from rotating in the width direction of the door D. Further, the length of the rotary shaft 114 of the open degree adjustment block 15 and the width dimension of the open degree adjustment block 15 in the extending direction of the rotary shaft 114 are substantially the same as the width dimension of the door check 11 in the extending direction of the rotary shaft 114. Thus, the increase in width dimension of the door D resulting from providing the open degree adjustment block may be restrained. In addition, the open degree adjustment block 15 according to the present embodiment is biased by the biasing member 17 in the direction where the first contact portion 151 makes contact with the door check 11. Thus, the open degree adjustment block 15 is biased at the position abutting the check link 12 so as to maintain the state where the first contact portion 151 is in contact with the door check 11. Even in a case where the second contact portion 152 is inhibited from making contact with the stopper portion 13, looseness or rattle of the open degree adjustment block 15 arranged at the position abutting the check link 12 may be inhibited.

In the door check mechanism 10 of the present embodiment, the open degree adjustment block 15 rotates on a basis of the movement of the connection member 16 connected to the operation portion. At this time, the construction for rotating the open degree adjustment block 15 is not limited to the above. For example, the open degree adjustment block 15 may rotate by a motor which rotates the open degree adjustment block 15 and an arbitrary connection member such as a wiring, for example, connected to the operation portion to transmit an input signal from the operation portion to the motor. In this case, the input signal is transmitted to the motor via the connection member based on the operation of the operation portion by the user to drive the motor so that the open degree adjustment block 15 or the rotary shaft 114 to which the open degree adjustment block 15 is connected may rotate.

In addition, in the door check mechanism 10 of the present embodiment, the door check 11 is arranged so that the case portion 111 of the door check 11 is mounted to the door D. Alternatively, the door check 11 may be arranged so that the base portion 112 of the door check 11 is mounted to the door D. In this case, the open degree adjustment block makes contact with the case portion 111 of the door check 11. Even in this case, the open degree adjustment block is constructed so that at least a portion of the first contact portion of the open degree adjustment block 15 makes contact with the solid portion such as the frame portion 118 and the thick portion of the case portion 111 of the door check 11 to thereby restrain the deformation of the door check 11 caused by the load transmitted from the stopper portion 13 via the open degree adjustment block.

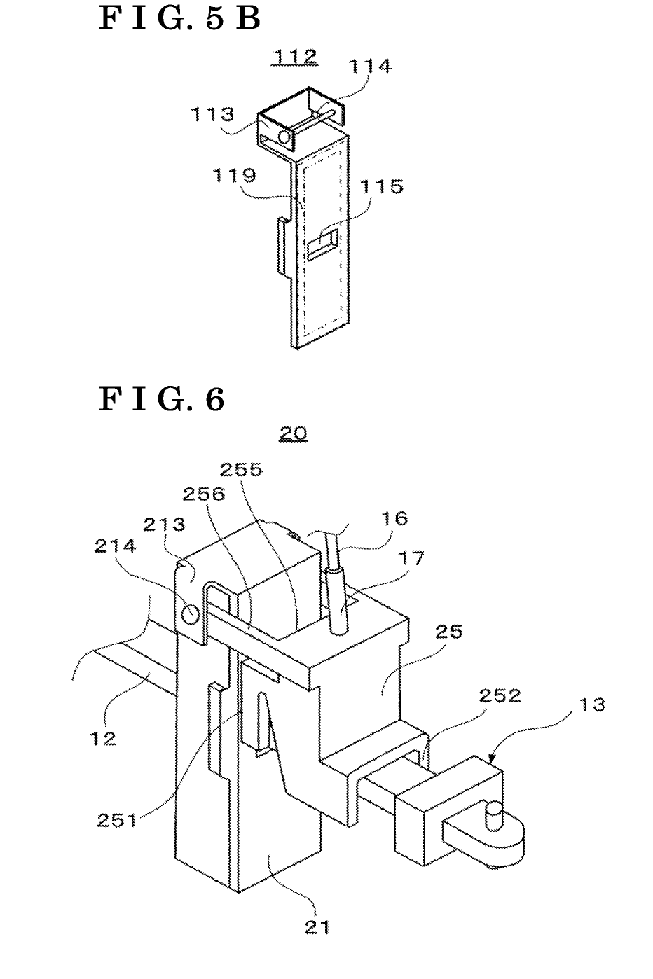

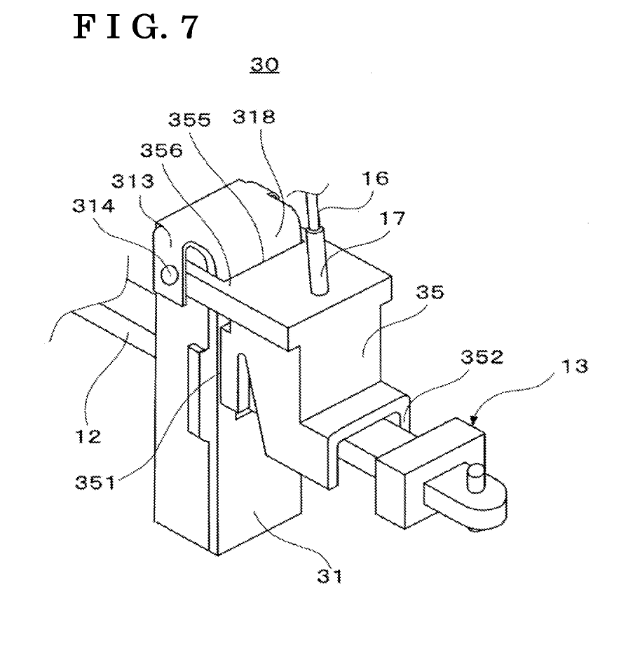

Further, in the door check mechanism 10 of the present embodiment, the rotary shaft 114 of the open degree adjustment block 15 for rotating the open degree adjustment block 15 in the up-down direction is arranged at the top portion of the door check 11. At this time, the construction for rotating the open degree adjustment block in the up-down direction is not limited to the above. Modified examples of the door check mechanism where the rotary shaft of the open degree adjustment block for rotating the open degree adjustment block in the up-down direction is provided at a lateral portion of the door check 11 are explained with reference to FIGS. 6 and 7. In FIGS. 6 and 7, the illustrations of the vehicle body B, the door D and the bracket 14 are omitted for the purpose of simple explanation. Operations and functions, for example, of the open degree adjustment block according to the modified examples are similar to those of the open degree adjustment block 15 according to the first embodiment and thus differences are mainly explained.

FIG. 6 illustrates a door check mechanism 20 serving as an example where the rotary shaft of the open degree adjustment block for rotating the open degree adjustment block in the up-down direction is provided at the lateral portion of the door check. The door check mechanism 20 includes a door check 21 and an open degree adjustment block 25 in place of the door check 11 and the open degree adjustment block 15 at the door check mechanism 10 according to the first embodiment.

In the door check 21, bearing portions 213 and a rotary shaft 214 of the open degree adjustment block 25 are provided at opposed lateral portions of the door check 21.

The open degree adjustment block 25 includes a first contact portion 251 configured to make contact with the door check 21, a second contact portion 252 configured to make contact with the stopper portion 13, connection portions 256 connected to the rotary shaft 214 and a cut portion 255. The open degree adjustment block 25 is rotatable in the up-down direction about the rotary shaft 214 which passes through bore portions (not illustrated) provided at the connection portion 256. In the open degree adjustment block 25, the cut portion 255 obtained by cutting the first contact portion 251 by a predetermined width, i.e., by a predetermined distance in the longitudinal direction of the check link 12, is provided in the vicinity of the rotary shaft 214. Because the cut portion 255 is provided, the first contact portion 251 is avoidable from making contact with the door check 21 in a case where the open degree adjustment block 25 rotates in the upper direction from a state illustrated in FIG. 6. It is avoidable that the rotation of the open degree adjustment block 25 in the upper direction is restricted by the first contact portion 251 so that the open degree adjustment block 25 is rotatable in the upper direction. In addition, in the rotation opposite from the upper direction, concentration of a load generated by the contact between the first contact portion 251 and the door check 21 in a portion of the first contact portion 251 in the vicinity of the rotary shaft 214 is avoidable in a case where the open degree adjustment block 25 rotates to the state illustrated in FIG. 6.

Accordingly, even in the door check mechanism 20 where the rotary shaft 214 of the open degree adjustment block 25 is provided at the lateral portion of the door check 21, the open degree adjustment block 25 may be arranged between the door check 21 and the stopper portion 13 by the rotation of the open degree adjustment block 25 in the up-down direction based on the movement of the connection member 16 connected to the operation portion. Therefore, the movement of the check link 12 in the direction of the one end portion thereof mounted to the vehicle body B may be restricted by the open degree adjustment block 25 to thereby restrain the open degree of the door D.

FIG. 7 illustrates a door check mechanism 30 serving as another example where the rotary shaft of the open degree adjustment block is provided at the lateral portion of the door check so as to rotate the open degree adjustment block in the up-down direction. The door check mechanism 30 includes a door check 31 and an open degree adjustment block 35 in place of the door check 21 and the open degree adjustment block 25 at the door check mechanism 20. In the door check mechanism 30, a depth of a cut portion 355 is relatively shallow as compared to the construction of the door check mechanism 20. In addition, a portion 318 of the door check 31 positioned at the upper side of a rotary shaft 314 and facing the stopper portion 13 is formed being round along the rotation direction of the open degree adjustment block 35.

In the door check 31, bearing portions 313 and the rotary shaft 314 of the open degree adjustment block 35 are provided at opposed lateral portions of the door check 31. In addition, the portion 318 of the door check 31 positioned at the upper side of the rotary shaft 314 and facing the stopper portion 13 is formed being round along the rotation direction of the open degree adjustment block 35, i.e., formed including a curving surface.

The open degree adjustment block 35 includes a first contact portion 351 configured to make contact with the door check 31, a second contact portion 352 configured to make contact with the stopper portion 13, connection portions 356 connected to the rotary shaft 314 and the cut portion 355. The open degree adjustment block 35 is rotatable about the rotary shaft 314 passing through bore portions (not illustrated) provided at the respective connection portions 356. In the open degree adjustment block 35, the cut portion 355 obtained by cutting the first contact portion 351 by a predetermined distance in the longitudinal direction of the check link 12 is provided in the vicinity of the rotary shaft 314. Because the cut portion 355 is provided, concentration of a load generated by the contact between the first contact portion 351 and the door check 31 in a portion of the first contact portion 351 in the vicinity of the rotary shaft 314 is avoidable in a case where the open degree adjustment block 35 rotates from the upper side to the state illustrated in FIG. 7.

In the door check mechanism 30, the cut portion 355 is formed being relatively shallow as compared to the cut portion 255 of the door check mechanism 20. In addition, the portion 318 of the door check 31 positioned at the upper side of the rotary shaft 314 and facing the stopper portion 13 is formed being round along the rotation direction of the open degree adjustment block 35. Thus, the first contact portion 351 is avoidable from making contact with the portion 318 of the door check 31 in a case where the open degree adjustment block 35 rotates in the upper direction from the state illustrated in FIG. 7. The open degree adjustment block 35 is therefore rotatable in the upper direction.

Accordingly, even in the door check mechanism 30 where the rotary shaft 314 of the open degree adjustment block 35 is provided at the lateral portion of the door check 31, the open degree adjustment block 35 may be arranged between the door check 31 and the stopper portion 13 by the rotation of the open degree adjustment block 35 in the up-down direction based on the movement of the connection member 16 connected to the operation portion. Therefore, the movement of the check link 12 in the direction of the one end portion thereof mounted to the vehicle body B may be restricted by the open degree adjustment block 35 to restrict the open degree of the door D.

The rotary shaft 214, 314 at the door check mechanism 20, 30 may be provided at each side of the opposed lateral portions of the door check 21, 31 or provided penetrating through the door check 21, 31. In a case where the rotary shaft 214, 314 is provided by penetrating through the door check 21, 31, the rotary shaft 214, 314 may be provided at a position so as not to influence an internal configuration of the door check 21, 31, i.e., the pressing portions and the biasing members.

In the door check mechanism 20, 30, the open degree adjustment block 25, 35 is configured to rotate in the up-down direction at the upper side of the door check 21, 31. Alternatively, the door check 21, 31 may be configured to rotate in the up-down direction at the lower side of the door check 21, 31. The rotation direction of the open degree adjustment block 25, 35 is not limited to the up-down direction. For example, the rotary shaft of the open degree adjustment block may be provided so that the open degree adjustment block rotates in a lateral direction relative to the door check. In this case, the rotary shaft of the open degree adjustment block is provided at the top portion and the bottom portion of the door check. In this case, the cut portion of the open degree adjustment block or the round portion of the door check is formed depending on the rotation direction of the open degree adjustment block so as to rotate the open degree adjustment block.

In FIGS. 6 and 7, the bearing portions 213, 313 at the door check mechanism 20, 30 are provided at the base portion of the door check 21, 31. At this time, the member at which the bearing portions 213, 313 are provided is not limited to the base portion. For example, the bearing portions 213, 313 may be provided at the case portion of the door check 21, 31 or at a separate member from the case portion or the base portion mounted to the door check mechanism 20, 30 or the door D.

Further, in the door check mechanism 10 of the present embodiment, the door check 11 is employed as the movement restricting member. At this time, the movement restricting member is not limited to the door check 11. The movement restricting member may be at least a member which makes contact with the first contact portion 151 of the open degree adjustment block 15 so as to restrict the movement of the open degree adjustment block 15 in the direction of the one end of the check link 12 mounted to the vehicle body B. Thus, the movement restricting member may be another member which is mounted to the door D and which makes contact with the first contact portion 151 of the open degree adjustment block 15 so as to restrict the movement of the open degree adjustment block 15 in the direction of the one end of the check link 12 mounted to the vehicle body B. In addition, the movement restricting member may be a member integrally constituted with the door D to exercise the similar function.

Furthermore, in the door check mechanism 10 of the present embodiment, the first contact portion 151 of the open degree adjustment block 15 is provided as a surface making contact with the door check 11 depending on the rotation of the open degree adjustment block 15 in a case where the open degree adjustment block 15 rotates towards the check link 12. At this time, the construction of the first contact portion which makes contact with the door check 11 serving as the movement restricting member is not limited to the above. The first contact portion may be at least a portion of the open degree adjustment block which makes contact with the movement restriction portion to restrict the movement of the open degree adjustment block in the direction of the one end of the check link 12 mounted to the vehicle body B.

Accordingly, the first contact portion may be a protruding portion provided at the open degree adjustment block and engaging with a bore portion, not illustrated, provided at the door check, the protruding portion functioning as the rotary shaft of the open degree adjustment block. In this case, the protruding portion makes contact with the bore portion, not illustrated, provided at the door check so that the door check may restrict the open degree adjustment block from moving in the direction of the one end portion of the check link 12 mounted to the vehicle body B. The aforementioned protruding portion may be integrally provided at the open degree adjustment block or constituted by a separate member such as a pin, for example, so as to be provided at the open degree adjustment block. In addition, a bore portion may be provided at the open degree adjustment block while a protruding portion which engages with the bore portion may be provided at the movement restricting member such as the door check, for example. In this case, the bore portion of the open degree adjustment block may function as a first portion which makes contact with the protruding portion of the door check.

### Second Embodiment

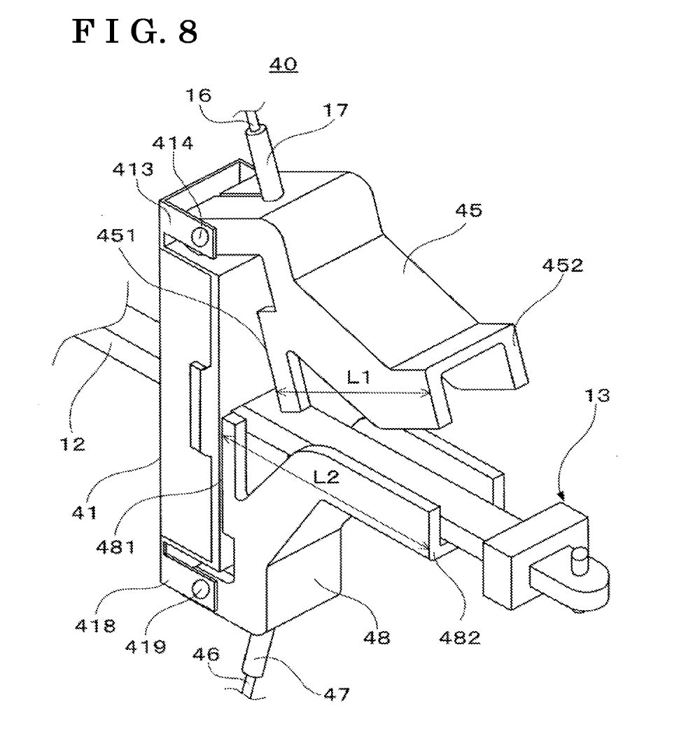

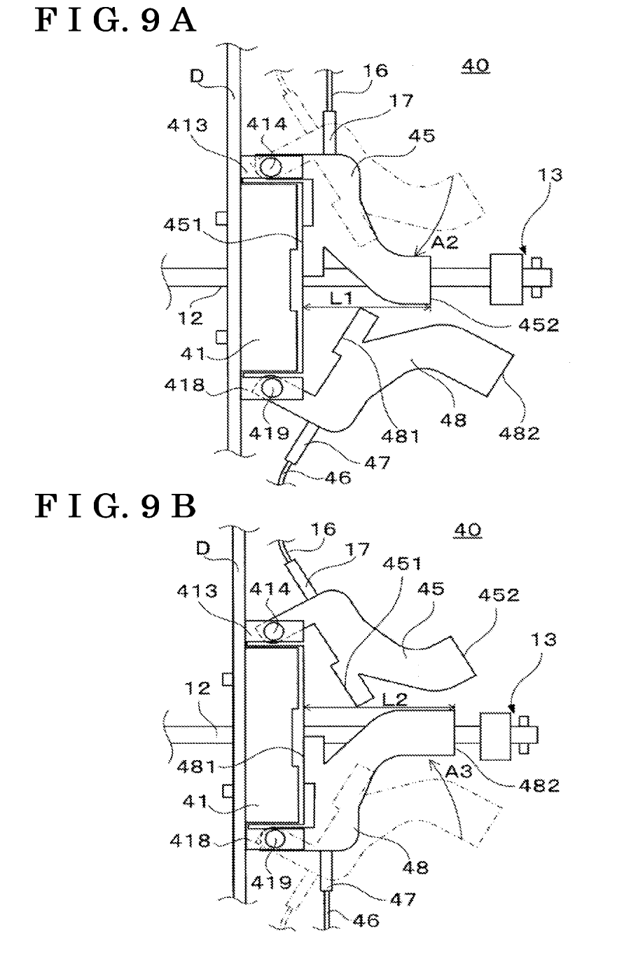

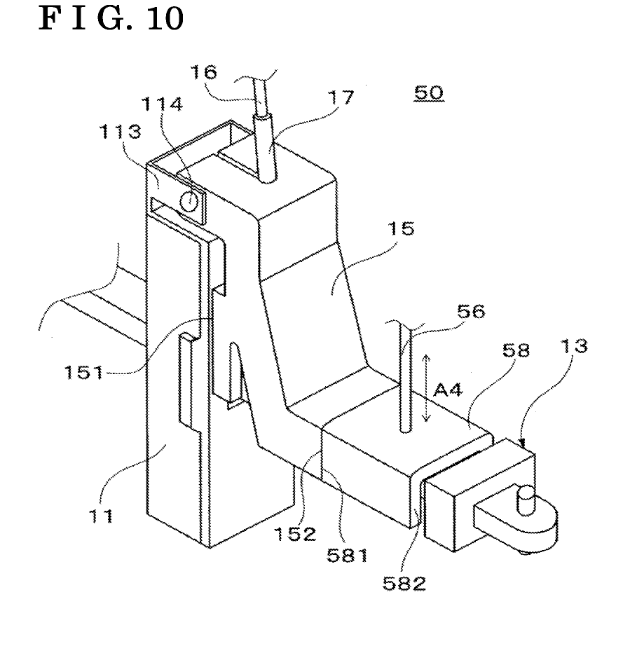

In the door check mechanism 10 according to the first embodiment, the single open degree adjustment block 15 is employed to restrict the open degree of the door D. On the other hand, a door check mechanism 40 according to a second embodiment of the invention includes two open degree adjustment blocks which are explained with reference to FIGS. 8, 9A and 9B. The two open degree adjustment blocks differ from each other in distance from the contact portion making contact with the door check to the contact portion making contact with the stopper portion. In the door check mechanism 40 according to the second embodiment, the two open degree adjustment blocks which differ in the distance from the contact portion configured to make contact with the door check to the contact portion configured to make contact with the stopper portion are employed to restrict the open degree of the door D in a stepwise manner. Operations and functions, for example, of the open degree adjustment block in the door check mechanism 40 are similar to those of the open degree adjustment block 15 according to the first embodiment and thus differences are mainly explained.

FIG. 8 illustrates the door check mechanism 40 according to the present embodiment. In FIG. 8, the illustrations of the vehicle body B, the door D and the bracket 14 are omitted for the purpose of simple explanation. The door check mechanism 40 includes a door check 41, the check link 12, the stopper portion 13, the bracket 14, a first open degree adjustment block 45 and a second open degree adjustment block 48 (another open degree adjustment block).

As illustrated in FIG. 8, the door check 41 includes bearing portions 413 supporting a rotary shaft 414 of the first open degree adjustment block 45 at a top portion of the door check 41 and includes bearing portions 418 supporting a rotary shaft 419 of the second open degree adjustment block 48 at a bottom portion of the door check 41.

The first open degree adjustment block 45 includes a first contact portion 451 configured to make contact with the door check 41 and a second contact portion 452 which is opposed to the first contact portion 451 while including a predetermined distance L1 from the first contact portion 451 and which is configured to make contact with the stopper portion 13. The first open degree adjustment block 45 is rotatable about the rotary shaft 414 provided at the top portion of the door check 41. The first open degree adjustment block 45 is connected to the operation portion, not illustrated, via the connection member 16 so as to be rotatable about the rotary shaft 414 based on the operation of the operation portion by the user. Further, the first open degree adjustment block 45 is biased to a position between the door check 41 and the stopper portion 13, i.e., in a direction towards a position abutting the check link 12, by the biasing member 17.

The second open degree adjustment block 48 includes a third contact portion 481 configured to make contact with the door check 41 and a fourth contact portion 482 which is opposed to the third contact portion 481 while including a predetermined distance L2 from the third contact portion 481 and which is configured to make contact with the stopper portion 13. The second open degree adjustment block 48 is rotatable about the rotary shaft 419 provided at the bottom portion of the door check 41, being different from the rotary shaft 414 of the first open degree adjustment block 45. The second open degree adjustment block 48 is connected to an operation portion which is not illustrated, via an arbitrary connection member 46 such as a wire, a cable and a bar-formed member (a rod), for example. The second open degree adjustment block 48 is rotatable about the rotary shaft 419 based on the operation of the operation portion by the user. Further, the second open degree adjustment block 48 is biased by a biasing member 47 to a position between the door check 41 and the stopper portion 13, i.e., in a direction towards a position abutting the check link 12. The second open degree adjustment block 48 is provided so that the distance L2 between the third contact portion 481 and the fourth contact portion 482 of the second open degree adjustment block 48 is longer than the distance L1 between the first contact portion 451 and the second contact portion 452 of the first open degree adjustment block 45.

Next, an operation of the door check mechanism 40 according to the present embodiment is explained with reference to FIGS. 9A and 9B. FIG. 9A illustrates the operation of the door check mechanism 40 in a case where the open degree of the door D is restricted to a first open degree by the first open degree adjustment block 45. FIG. 9B illustrates the operation of the door check mechanism 40 in a case where the open degree of the door D is restricted to a second open degree by the second open degree adjustment block 48, the second open degree being smaller than the first open degree. In FIG. 9A, the position of the first open degree adjustment block 45 illustrated by an alternate long and two short dashes line indicates the position of the first open degree adjustment block 45 in a case where the open degree of the door D is not restricted to the first open degree. In FIG. 9B, the position of the second open degree adjustment block 48 illustrated by an alternate long and two short dashes line indicates the position of the second open degree adjustment block 48 in a case where the open degree of the door D is not restricted to the second open degree. In FIGS. 9A and 9B, the illustrations of the vehicle body B and the bracket 14 are omitted for the purpose of simple explanation.

In a case where the user operates the operation portion to restrict the open degree of the door D to the first open degree, the first open degree adjustment block 45 rotates in a direction indicated by an arrow A2 from an upper position of the door check 41 indicated by the alternate long and two short dashes line in FIG. 9A based on the movement of the connection member 16 connected to the operation portion. The first open degree adjustment block 45 rotates and moves to a position at which the first contact portion 451 makes contact with the door check 41 and the first open degree adjustment block 45 abuts the check link 12. When the door D is opened after the first open degree adjustment block 45 rotates to the aforementioned position, the stopper portion 13 makes contact with the second contact portion 452 which is opposed to the first contact portion 451 so that the movements of the stopper portion 13 and the check link 12 in the direction of the one end portion of the check link 12 mounted to the vehicle body B is restricted. Accordingly, with the usage of the first open degree adjustment block 45, the open degree of the door D may be restricted to the first open degree based on the distance L1 between the first contact portion 451 and the second contact portion 452.

In a case where the user operates the operation portion to restrict the open degree of the door D to the second open degree which is smaller than the first open degree, the second open degree adjustment block 48 rotates in a direction indicated by an arrow A3 from a lower position of the door check 41 indicated by the alternate long and two short dashes line in FIG. 9B based on the movement of the connection member 16 connected to the operation portion. The second open degree adjustment block 48 rotates and moves to a position at which the third contact portion 481 makes contact with the door check 41 and the second open degree adjustment block 48 abuts the check link 12. When the door D is opened after the second open degree adjustment block 48 rotates to the aforementioned position, the stopper portion 13 makes contact with the fourth contact portion 482 which is opposed to the third contact portion 481 so that the movements of the stopper portion 13 and the check link 12 in the direction of the one end portion of the check link 12 mounted to the vehicle body B is restricted. Accordingly, with the usage of the second open degree adjustment block 48, the open degree of the door D may be restricted to the second open degree based on the distance L2 between the third contact portion 481 and the fourth contact portion 482. At this time, the distance L2 between the third contact portion 481 and the fourth contact portion 482 is longer than the distance L1 between the first contact portion 451 and the second contact portion 452. Thus, in a case where the open degree of the door D is restricted to the second open degree, the movement of the check link 12 in the direction of the one end portion thereof mounted to the vehicle body B is restricted by a longer distance as compared to a case where the open degree of the door D is restricted to the first open degree. Therefore, in a case where the open degree of the door D is restricted to the second open degree, the open degree of the door D is restricted to be narrower as compared to the case where the open degree is restricted to the first open degree. Accordingly, the usage of the two open degree adjustment blocks 45 and 48 which differ from each other in the distance from the contact portion making contact with the door check 41 to the contact portion making contact with the stopper portion 13 may result in the restriction of the open degree of the door D in a stepwise manner.

As mentioned above, the door check mechanism 40 according to the present embodiment includes the second open degree adjustment block 48 which rotates relative to the check link 12, in addition to the first open degree adjustment block 45. The second open degree adjustment block 48 includes the third contact portion 481 configured to make contact with the door check 41 and the fourth contact portion 482 which is opposed to the third contact portion 481 while including the predetermined distance L2 from the third contact portion 481 and which is configured to make contact with the stopper portion 13. The distance L2 between the third contact portion 481 and the fourth contact portion 482 is longer than the distance L1 between the first contact portion 451 and the second contact portion 452 of the first open degree adjustment block 45. Thus, the door check mechanism 40 may restrict the open degree of the door D in a stepwise manner with the usage of the first open degree adjustment block 45 and the second open degree adjustment block 48 based on the distances L1 and L2 by restricting the movement of the check link 12 in the direction of the one end portion of the check link 12 mounted to the vehicle body B.

The door check mechanism 40 according to the present embodiment may be constructed, in the same manner as the door check mechanism 10 according to the first embodiment, so that at least a portion of each of the first contact portion 451 and the third contact portion 481 makes contact with the solid portion of the door check 41. In this case, deformation of the door check 41 caused by a load transmitted from the stopper portion 13 to the door check 41 via the first open degree adjustment block 45 or the second open degree adjustment block 48 when the door D is opened may be restrained.

In addition, as illustrated in FIGS. 8 to 9B, each of the open degree adjustment blocks 45 and 48 includes a cut portion in the vicinity of each of the rotary shafts 414 and 419, the cut portion being obtained by cutting each of the first contact portion 451 and the third contact portion 481 by a predetermined distance in the longitudinal direction of the check link 12. As a result, a load generated when the first contact portion 451 makes contact with the door check 41 by the rotation of the first open degree adjustment block 45 to the position abutting the check link 12 is avoidable from being concentrated in a portion of the first contact portion 451 in the vicinity of the rotary shaft 414. In the similar manner, a load generated when the third contact portion 481 makes contact with the door check 41 by the rotation of the second open degree adjustment block 48 to the position abutting the check link 12 is avoidable from being concentrated in a portion of the third contact portion 481 in the vicinity of the rotary shaft 419.

Further, the first open degree adjustment block 45 is biased in the direction where the first contact portion 451 makes contact with the door check 41 by means of the biasing member 17, in the same way as the open degree adjustment block 15 at the door check mechanism 10 according to the first embodiment. Accordingly, the first open degree adjustment block 45 is biased, at the position abutting the check link 12, to maintain the state where the first contact portion 451 is in contact with the door check 41. Thus, even in a case where the second contact portion 452 is inhibited from making contact with the stopper portion 13 when the open degree of the door D is specified to the first open degree, looseness or rattle of the open degree adjustment block 45 arranged at the position abutting the check link 12 may be inhibited. In addition, the second open degree adjustment block 48 is biased in the direction where the third contact portion 481 makes contact with the door check 41 by the biasing member 47, in the same way as the open degree adjustment block 15 at the door check mechanism 10 according to the first embodiment. Therefore, the second open degree adjustment block 48 is biased, at the position abutting the check link 12, to maintain the state where the third contact portion 481 is in contact with the door check 41. Thus, even in a case where the fourth contact portion 482 is inhibited from making contact with the stopper portion 13 when the open degree of the door D is specified to the second open degree, looseness or rattle of the open degree adjustment block 48 arranged at the position abutting the check link 12 may be inhibited.

The positions at which the rotary shafts 414 and 419 of the first open degree adjustment block 45 and the second open degree adjustment block 48 are provided and the directions of the rotary shafts 414 and 419 may be arbitrarily specified in the same manner as changing the position and direction of the rotary shaft in the door check mechanism 40 according to the first embodiment. That is, each of the rotary shafts 414 and 419 of the first open degree adjustment block 45 and the second open degree adjustment block 48 may be provided at the base portion or the case portion of the door check 41 or a different member form the base portion or the case portion. The directions of the rotary shafts of the first and second open degree adjustment blocks may be arbitrarily specified so that each of the first and second open degree adjustment blocks rotates while securing an angle relative to the check link 12 and is rotatable to the position sandwiched between the door check 41 and the stopper portion 13. Each of the rotary shafts of the first and second open degree adjustment blocks may be provided at a portion opposed to the door check 41, for example, the opposed lateral portions, the top portion and the bottom portion, as in the door check mechanisms 20 and 30 serving as the modified examples of the door check mechanism 10 according to the first embodiment.

In the present embodiment, the door check mechanism 40 is configured so that the second open degree adjustment block 48 rotates about the rotary shaft 419 different from the rotary shaft 414 of the first open degree adjustment block 45. Alternatively, the first open degree adjustment block and the second open degree adjustment block may be configured to rotate about the same rotary shaft. For example, the second open degree adjustment block may be configured to cover the first open degree adjustment block by increasing the width dimension of the second open degree adjustment block relative to the width dimension of the first open degree adjustment block. In this case, even though the first and second open degree adjustment blocks rotate about the same rotary shaft, the second open degree adjustment block may be arranged between the door check 41 and the stopper portion 13 while covering the first open degree adjustment block. The open degree of the door D may be thus restricted in a stepwise manner.

In the door check mechanism 40 of the present embodiment, each of the first and second open degree adjustment blocks 45 and 48 may rotate by a motor. In this case, the motor for rotating each of the first and second open degree adjustment block 45 and 48 and an arbitrary connection member such as a wiring, for example, connected to the operation portion to transmit an input signal from the operation portion to the motor may be employed.

In the door check mechanism 40 of the present embodiment, only one of the first open degree adjustment block 45 and the second open degree adjustment block 48 is configured to move to the position at which the open degree of the door D is restricted, i.e., to the position between the door check 41 and the stopper portion 13. Thus, in a case of changing the restriction of the open degree of the door D, the rotations of the first open degree adjustment block 45 and the second open degree adjustment block 48 are controlled to thereby inhibit one of the open degree adjustment blocks from disturbing the rotation of the other of the open degree adjustment blocks. The aforementioned control of the rotations may be performed mechanically by means of a connection member such as a wiring, for example, or electrically by means of an electrical signal. The aforementioned control of the rotations includes interlocking the rotations of the open degree adjustment blocks by means of an arbitrary interlocking member, for example, rotating one of the open degree adjustment blocks which restricts the open degree of the door to thereby release the restriction of the open degree of the door D and thereafter rotating the other of the open degree adjustment blocks, and the like. In addition, configurations of the first and second open degree adjustment blocks may be adjusted so that the open degree adjustment blocks are simultaneously movable to positions at which the open degree of the door D is restricted. In this case, when the restriction of the open degree of the door D is changed, one of the open degree adjustment blocks is inhibited from disturbing the rotation of the other of the open degree adjustment blocks in the vicinity of the check link 12.

Further, in the door check mechanism 40 of the present embodiment, the open degree of the door D is restricted in a stepwise manner by the two open degree adjustment blocks 45 and 48 which differ in the distance from the contact portion configured to make contact with the door check 41 to the contact portion configured to make contact with the stopper portion 13. Alternatively, three or more of the open degree adjustment blocks which differ in the distance from the contact portion configured to make contact with the door check to the contact portion configured to make contact with the stopper portion may be provided. For example, further another rotary shaft may be provided at the lateral side of the door check. Then, the third open degree adjustment block which rotates about the aforementioned rotary shaft towards the check link 12 may be provided. In this case, the open degree of the door D may be restricted in a stepwise manner depending on the number of open degree adjustment blocks.

### Third Embodiment

In the second embodiment, the open degree of the door D is restricted in a stepwise manner by the two open degree adjustment blocks 45 and 48 which rotate about the respective rotary shafts and which differ in the distance from the contact portion configured to make contact with the door check 41 to the contact portion configured to make contact with the stopper portion 13. Here, a door check mechanism 50 which restricts the open degree of the door D in a stepwise manner by the second open degree adjustment block arranged between the first open degree adjustment block and the stopper portion is explained with reference to FIG. 10. The door check mechanism 50 according to a third embodiment is similar to the door check mechanism 10 according to the first embodiment except for including the second open degree adjustment block arranged between the first open degree adjustment block and the stopper portion. Thus, differences from the door check mechanism 10 according to the first embodiment are mainly explained.

FIG. 10 illustrates the door check mechanism 50 according to the present embodiment. In FIG. 10, the illustrations of the vehicle body B, the door D and the bracket 14 are omitted for the purpose of simple explanation. The door check mechanism 50 includes the door check 11, the check link 12, the stopper portion 13, the bracket 14, the first open degree adjustment block 15 and a second open degree adjustment block 58 (another open degree adjustment block). Components in the door check mechanism 50 other than the second open degree adjustment block 58 and a connection member 56 are the same as those in the door check mechanism 10 according to the first embodiment. Thus, the same reference numerals are assigned to the same components and explanations are omitted.

The second open degree adjustment block 58 includes a third contact portion 581 configured to make contact with the second contact portion 152 of the first open degree adjustment block 15 and a fourth contact portion 582 configured to make contact with the stopper portion 13. The fourth contact portion 582 is opposed to the third contact portion 581 while including a predetermined distance from the third contact portion 581. The second open degree adjustment block 58 is connected to an operation portion, not illustrated, via the arbitrary connection member 56 such as a wire, a cable and a bar-formed member (a rod), for example. Thus, the second open degree adjustment block 58 is slidably movable in the up-down direction relative to the check link 12 as indicated by an arrow A4 based on the operation of the operation portion by the user. The second open degree adjustment block 58 is movable to a position at the upper side of the check link 12 for not restricting the open degree of the door D or to a position between the second contact portion 152 and the stopper portion 13 of the first open degree adjustment block 15 for restricting the open degree of the door D by sliding in accordance with the operation of the user.

The second open degree adjustment block 58 is movable to the position between the first open degree adjustment block 15 and the stopper portion 13 in a case where the first open degree adjustment block 15 is disposed at a position for restricting the open degree of the door D, i.e., arranged at the position between the door check 11 and the stopper portion 13. In a case where the door D is opened after the second open degree adjustment block 58 moves to the position between the first open degree adjustment block 15 and the stopper portion 13, the third contact portion 581 makes contact with the second contact portion 152 of the first open degree adjustment block 15 and the stopper portion 13 makes contact with the fourth contact portion 582. As a result, the first and second open degree adjustment blocks 15 and 48 are sandwiched between the door check 11 and the stopper portion 13. Thus, the first and second open degree adjustment blocks 15 and 58 may restrict the check link 12 from moving in the direction of the one end portion of the check link 12 mounted to the vehicle body B, so that the open degree of the door D is restricted. At this time, the first and second open degree adjustment blocks 15 and 58 restrict the movement of the check link 12 by a distance between the first contact portion 151 and the second contact portion 152 and a distance between the third contact portion 581 and the fourth contact portion 582. Therefore, as compared to a case where only the first open degree adjustment block 15 is sandwiched between the door check 11 and the stopper portion 13, the movement of the check link 12 may be restricted by a longer distance. The open degree of the door D may be further restricted to a narrow degree. The open degree of the door D may be restricted in a stepwise manner by means of the first and second open degree adjustment blocks 15 and 58.

As mentioned above, the door check mechanism 50 according to the present embodiment includes the second open degree adjustment block 58 (another open degree adjustment block) which moves relative to the check link 12, in addition to the components of the door check mechanism 10. The second open degree adjustment block 58 includes the third contact portion 581 configured to make contact with the second contact portion 152 of the first open degree adjustment block 15 and the fourth contact portion 582 opposed to the third contact portion 581 while including a predetermined distance from the third contact portion 581. The second open degree adjustment block 58 restricts the movement of the check link 12 in the direction of the one end portion mounted to the vehicle body B by moving towards the check link 12 so that the third contact portion 581 makes contact with the second contact portion 152 and the stopper portion 13 makes contact with the fourth contact portion 582. Accordingly, the first and second open degree adjustment blocks 15 and 58 restrict the movement of the check link 12 by the distance between the third contact portion 581 and the fourth contact portion 582 in addition to the distance between the first contact portion 151 and the second contact portion 152 of the first open degree adjustment block 15. As compared to a case where the open degree of the door D is restricted by the first open degree adjustment block 15, the movement of the check link 12 may be restricted by a further longer distance. The open degree of the door D may be restricted to a further narrower degree. The open degree of the door D may be restricted in a stepwise manner by the first open degree adjustment block 15 and the second open degree adjustment block 58 accordingly.

In the door check mechanism 50 according to the present embodiment, the second open degree adjustment block 58 is configured to slide in accordance with the operation of the operation portion via the connection member 56. At this time, the movement of the second open degree adjustment block is not limited to the sliding. For example, the second open degree adjustment block may be configured to move to the position between the first open degree adjustment block 15 and the stopper portion 13 by rotating, in the same manner as the first open degree adjustment block 15. In a case where the second open degree adjustment block 58 is configured to slide, an arbitrary guide member constituted by a protruding portion and a guide portion, for example, may be employed to inhibit a positioning error of the second open degree adjustment block 58.

The second open degree adjustment block 58 is arranged at the upper side of the check link 12. At this time, the arrangement of the second open degree adjustment block 58 relative to the check link 12 is not limited to the above. As long as the second open degree adjustment block 58 is configured to make contact with the first open degree adjustment block 15 and the stopper portion 13, the movement of the check link 12 may be restricted. Thus, the second open degree adjustment block may at least move to the position between the first open degree adjustment block 15 and the stopper portion 13 so as to make contact with the first open degree adjustment block 15 and the stopper portion 13. The second open degree adjustment block may be arranged in an arbitrary direction relative to the check link 12 so as to move to the position between the first open degree adjustment block 15 and the stopper portion 13. The moving direction of the second open degree adjustment block is not limited to the up-down direction. The second open degree adjustment block may be configured to move in an arbitrary direction so as to approach or separate from the check link 12 depending on the position where the second open degree adjustment block is disposed.

In the door check mechanism 50 according to the present embodiment, the second open degree adjustment block 58 is only employed as the open degree adjustment block which moves to the position between the first open degree adjustment block 15 and the stopper portion 13. At this time, the number of open degree adjustment blocks employed for restricting the open degree of the door D in a stepwise manner is not limited to one. For example, a third open degree adjustment block including the same configuration as the second open degree adjustment block and configured to move to the position between the second open degree adjustment block 58 and the stopper portion 13 may be employed in addition to the first open degree adjustment block 15 and the second open degree adjustment block 58. Three or more of the open degree adjustment blocks may be also employed.

### Fourth Embodiment

In the door check mechanism 40 according to the second embodiment, the two connection members 16 and 46 are employed as the connection members which connect the first and second open degree adjustment blocks 45 and 48 to the respective operation portions. Instead, the single connection member may be employed for moving the first and second open degree adjustment blocks based on the operation of the operation portion. In the door check mechanism according to a fourth embodiment, the first and second open degree adjustment blocks move by a link connected to the first and second open degree adjustment blocks and by the single connection member connected to the operation portion.

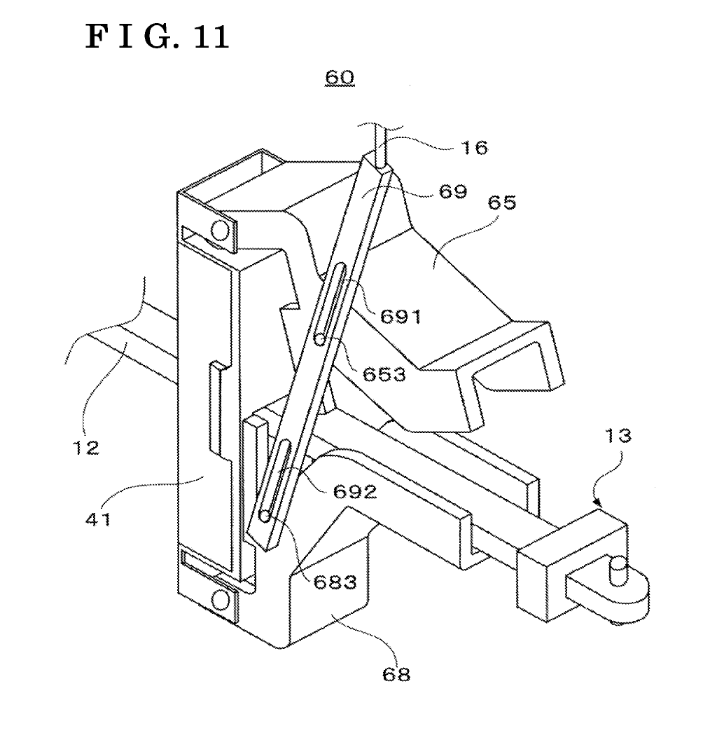

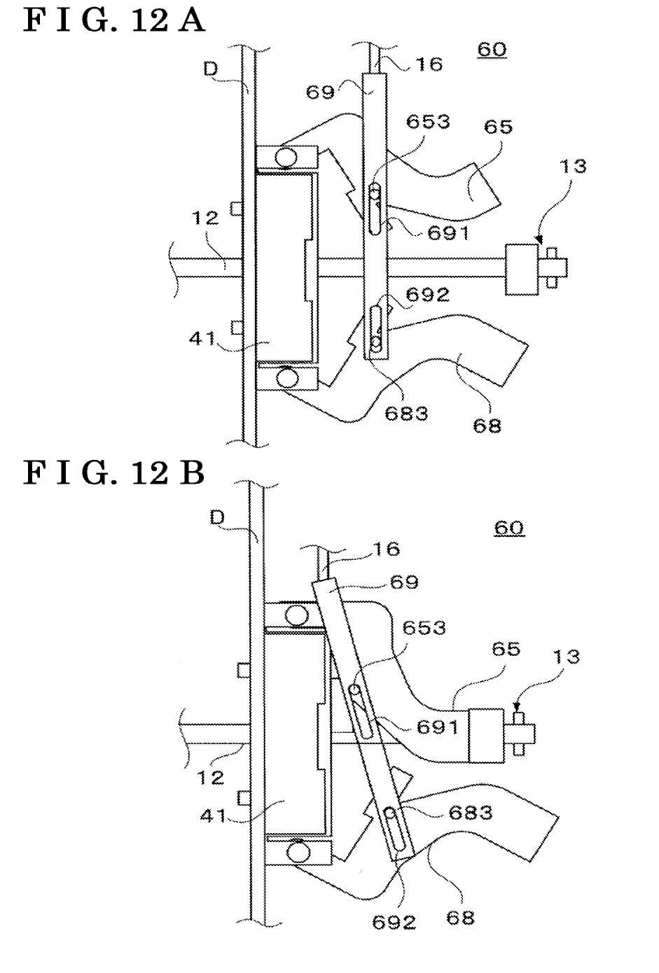

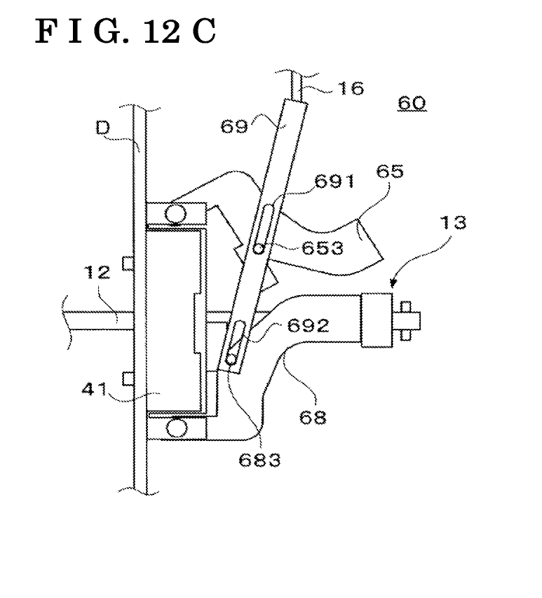

A door check mechanism 60 according to the present embodiment is explained with reference to FIGS. 11, 12A, 12B and 12C. The door check mechanism 60 according to the present embodiment includes the same construction as the door check mechanism 40 according to the second embodiment except for a construction for moving a first open degree adjustment block 65 and a second open degree adjustment block 68 by means of the single connection member 16 and a link 69. Thus, differences from the door check mechanism 40 according to the second embodiment are mainly explained below.

FIG. 11 illustrates the door check mechanism 60 according to the present embodiment. In FIG. 11, the illustrations of the vehicle body B, the door D and the bracket 14 are omitted for the purpose of simple explanation. The door check mechanism 60 includes the door check 41, the check link 12, the stopper portion 13, the bracket 14, the first open degree adjustment block 65, the second open degree adjustment block 68 and the link (coupling member) 69. The door check in the door check mechanism 60 is the same as the door check 41 of the door check mechanism 40 according to the second embodiment. Thus, the same reference numeral is assigned and explanation is omitted.

The first and second open degree adjustment blocks 65 and 68 are connected to the door check 41 to be movable in the up-down direction and are arranged in opposite directions from each other with respect to the check link 12. Each of the first and second open degree adjustment blocks 65 and 68 restricts the check link 12 from moving in the direction of the one side portion thereof mounted to the vehicle body B and restricts the open degree of the door D in a state being disposed and sandwiched between the door check 41 and the stopper portion 13. The first and second open degree adjustment blocks 65 and 68 are configured so that distances by which the first and second open degree adjustment blocks 65 and 68 are sandwiched between the door check 41 and the stopper portion 13 are different from each other. The open degree of the door D may be restricted depending on each of the aforementioned distances. Each of the first and second open degree adjustment blocks 65 and 68 is biased in a direction separating from the check link 12 by means of an arbitrary biasing member such as a torsion coil spring, a plate spring and a rubber member, for example.

A protruding portion 653 is provided at a lateral portion of the first open degree adjustment block 65. A protruding portion 683 is provided at a lateral portion of the second open degree adjustment block 68. The protruding portions 653 and 683 are provided at the lateral portions at the same side relative to the first open degree adjustment block 65 and the second open degree adjustment block 68 when viewed from the door check 41. The protruding portions 653 and 683 may be integrally provided at the open degree adjustment blocks 65 and 68 or may be provided as separate members, such as pins, for example, at the open degree adjustment blocks 65 and 68.

The link 69 is connected to the connection member 16 connected to the operation portion to move substantially in the up-down direction based on the operation of the operation portion by the user. The link 69 includes a first elongated bore portion 691 and a second elongated bore portion 692. Each of the first and second elongated bore portions 691 and 692 extends by a predetermined length in a longitudinal direction of the link 69.

The protruding portion 653 of the first open degree adjustment block 65 extends within the first elongated bore portion 691 of the link 69. The first open degree adjustment block 65 is connected to the link 69 by an engagement between the protruding portion 653 and the first elongated bore portion 691. The protruding portion 683 of the second open degree adjustment block 68 extends within the second elongated bore portion 692 of the link 69. The second open degree adjustment block 68 is connected to the link 69 by an engagement between the protruding portion 683 and the second elongated bore portion 692. Accordingly, the link 69 connects between the first and second open degree adjustment blocks 65 and 68.

Movements of the open degree adjustment blocks 65 and 68 by the link 69 in the door check mechanism 60 according to the present embodiment are explained with reference to FIGS. 12A to 12C. FIG. 12A illustrates the door check mechanism 60 in a case where the open degree of the door D is specified to the full open degree. FIG. 12B illustrates the door check mechanism 60 in a case where the open degree of the door D is specified to the first open degree by the first open degree adjustment block 65. FIG. 12C illustrates the door check mechanism 60 in a case where the open degree of the door D is specified to the second open degree by the second open degree adjustment block 68.

As illustrated in FIG. 12A, in a case where the open degree of the door D is specified to the full open degree, the link 69 is arranged, on a basis of the operation of the operation portion by the user, at a position for permitting the first and second open degree adjustment blocks 65 and 68 to be disposed at positions away from the check link 12. In this case, the stopper portion 13 is movable to a position making contact with the door check 41 based on the rotation of the door D. The door D may therefore open to the full open degree. In the door check mechanism 60 of the present embodiment, the first and second open degree adjustment blocks 65 and 68 are configured not to rotate beyond the aforementioned positions in a direction separating from the check link 12.

Next, when the user operates the operation portion to specify the open degree of the door D to the first open degree, the link 69 moves in the lower direction in accordance with the movement of the connection member 16 connected to the operation portion. In a case where the link 69 moves in the lower direction, the protruding portion 653 of the first open degree adjustment block 65 makes contact with an upper end portion of the first elongated bore portion 691 of the link 69. Thus, the first open degree adjustment block 65 rotates in the lower direction with the movement of the link 69 in the lower direction and moves to a position making contact with the door check 41 as illustrated in FIG. 12B. As a result, the first open degree adjustment block 65 is restricted by the door check 41 from moving in the direction of the one end portion of the check link 12 mounted to the vehicle body B. When the door D is opened, the first open degree adjustment block 65 makes contact with the stopper portion 13 to thereby restrict the movements of the check link 12 and the stopper portion 13 in the direction of the one end portion of the check link 12 mounted to the vehicle body B. The open degree of the door D may be therefore restricted to the first open degree by the first open degree adjustment block 65. In a case where the first open degree adjustment block 65 rotates, the protruding portion 683 of the second open degree adjustment block 68 is inhibited from making contact with an upper end portion of the second elongated bore portion 692 and moves within the second elongated bore portion 692.

When the user operates the operation portion to specify the open degree of the door D to the second open degree, the link 69 moves in the upper direction with the movement of the connection member 16 connected to the operation portion. In a case where the link 69 moves in the upper direction, the protruding portion 683 of the second open degree adjustment block 68 makes contact with a lower end portion of the second elongated bore portion 692 of the link 69. Thus, the second open degree adjustment block 68 rotates in the upper direction with the movement of the link 69 in the upper direction and moves to a position making contact with the door check 41 as illustrated in FIG. 12C. As a result, the second open degree adjustment block 68 is restricted by the door check 41 from moving in the direction of the one end portion of the check link 12 mounted to the vehicle body B. When the door D is opened, the second open degree adjustment block 68 makes contact with the stopper portion 13 to thereby restrict the movements of the check link 12 and the stopper portion 13 in the direction of the one end portion of the check link 12 mounted to the vehicle body B. The open degree of the door D may be therefore restricted to the second open degree by the second open degree adjustment block 68. In a case where the second open degree adjustment block 65 rotates, the protruding portion 653 of the first open degree adjustment block 65 is inhibited from making contact with a lower end portion of the first elongated bore portion 691 and moves within the first elongated bore portion 691.

As mentioned above, each of the first and second open degree adjustment blocks 65 and 68 is biased in the direction separating from the check link 12 by means of the biasing member not illustrated. Thus, in a case where an external force is not applied by the link 69 for rotating each of the first and second open degree adjustment blocks 65 and 68 towards the check link 12, each of the first and second open degree adjustment blocks 65 and 68 automatically moves to a position separating from the check link 12.

As mentioned above, in the door check mechanism 60 according to the present embodiment, the link 69 is provided being connected to the first and second open degree adjustment blocks 65 and 68 so as to connect between the first and second open degree adjustment blocks 65 and 68. Thus, with the single connection member 16, the first and second open degree adjustment blocks 65 and 68 are movable depending on the operation of the operation portion. Each of the two open degree adjustment blocks is operable with a simple configuration while a space for pulling and moving the connection member constituted by a wire or a bar-formed member, for example, may be reduced.

In the present embodiment, the link 69 is connected to the first and second open degree adjustment blocks 65 and 68 via the first and second elongated bore portions 691 and 692. Thus, in a case where one of the open degree adjustment blocks rotates towards the check link 12, the other of the open degree adjustment blocks is inhibited from moving in a direction further separating from the check link 12 from the position away from the check link 12 as illustrated in FIG. 12A. Thus, according to the present embodiment, a rotation range of each of the open degree adjustment blocks 65 and 68 is minimized to thereby reduce a space for mounting the door check mechanism 60.

At this time, the configuration of the link connected to the first and second open degree adjustment blocks is not limited to the above. For example, in a case where each of the first and second open degree adjustment blocks is rotatable in the direction separating from the check link 12 further than the first and second open degree adjustment block 65 and 68 of the present embodiment, the link may be simply rotatably connected to the first and second open degree adjustment blocks. In this case, upon restriction of the open degree of the door D, the open degree adjustment block which is not used for the restriction of the open degree of the door D moves in the direction further separating from the check link 12 with the movement of the link. As a result, the rotation range of the open degree adjustment block increases. Even in such case, the two open degree adjustment blocks are operable by the single connection member. In this case, because the first and second open degree adjustment blocks move integrally with the movement of the link, the first and second open degree adjustment blocks are not required to be biased by the biasing member in the direction separating from the check link 12.

In the present embodiment, the protruding portions 653 and 683 are provided at the first and second open degree adjustment blocks 65 and 68 while the first and second elongated bore portions 691 and 692 are provided at the link 69. Alternatively, the bore portions may be provided at the first and second open degree adjustment blocks while the protruding portions may be provided at the link.

The link 69 is configured to be movable substantially in the up-down direction. At this time, the moving direction of the link is not limited to the above. Because the link is a member for rotating the first and second open degree adjustment blocks, the link may be configured to be movable in an arbitrary direction depending on the rotation direction of each of the first and second open degree adjustment blocks. The protruding portions or the bore portions provided at the first and second open degree adjustment blocks are not limited to be provided at the lateral portions of the first and second open degree adjustment blocks. The protruding portions or the bore portions provided at the first and second open degree adjustment blocks may be provided at arbitrary portions thereof depending on the configuration of the link, for example, so that the protruding portions or the bore portions provided at the first and second open degree adjustment blocks engage with the bore portions or the protruding portions of the link and that the first and second open degree adjustment blocks are connectable by the link. Further, links which are coupled to each other may be provided at respective lateral portions of the first and second open degree adjustment blocks and the links may move by the single connection member.

### Fifth Embodiment

In the door check mechanism 40 according to the second embodiment, the first and second open degree adjustment blocks 45 and 48 rotate about the respective rotary shafts 414 and 419 provided at the top portion and the bottom portion of the door check 41. At this time, the configuration of the open degree adjustment block is not limited to the above. In the door check mechanism according to a fifth embodiment, the open degree adjustment block rotates about the rotary shaft which is provided at the lateral side of the door check and which extends in the longitudinal direction of the check link 12.

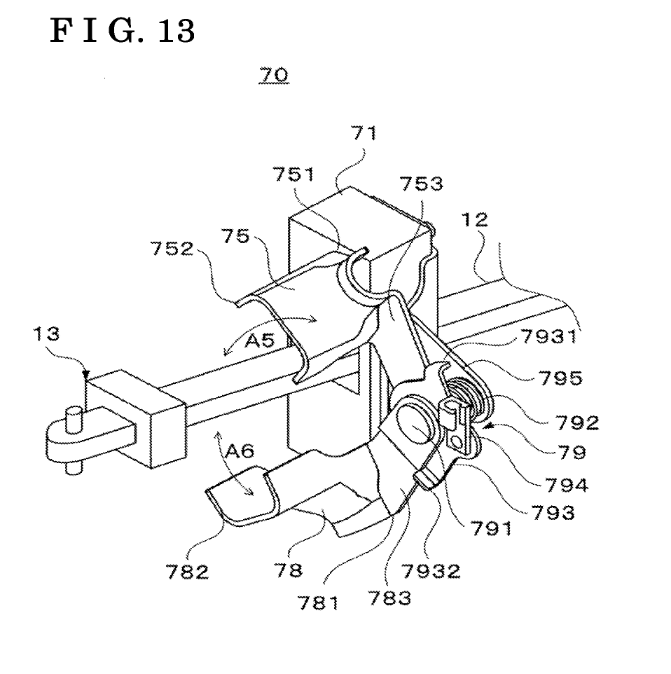

A door check mechanism 70 according to the present embodiment is explained with reference to FIGS. 13 to 15. In the door check mechanism 70 according to the present embodiment, the movement of the check link 12 and the operation for restricting the open degree of the door D, for example, are the same as those of the door check mechanism 40 according to the second embodiment. Thus, differences from the door check mechanism 40 according to the second embodiment are mainly explained below.

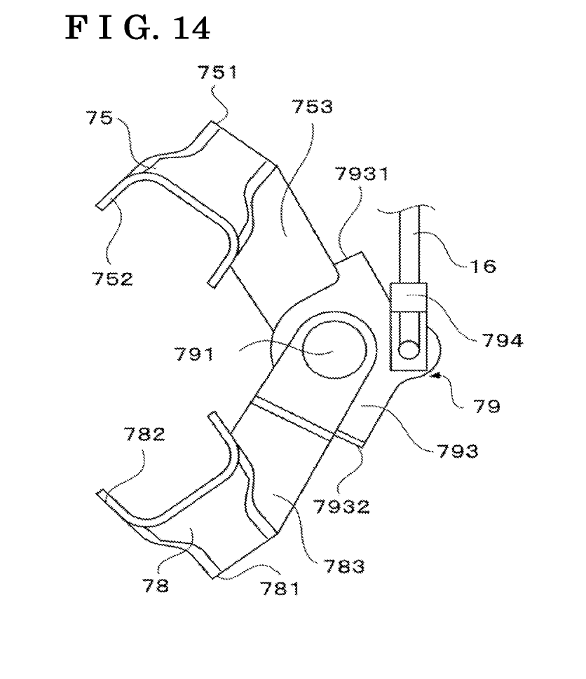

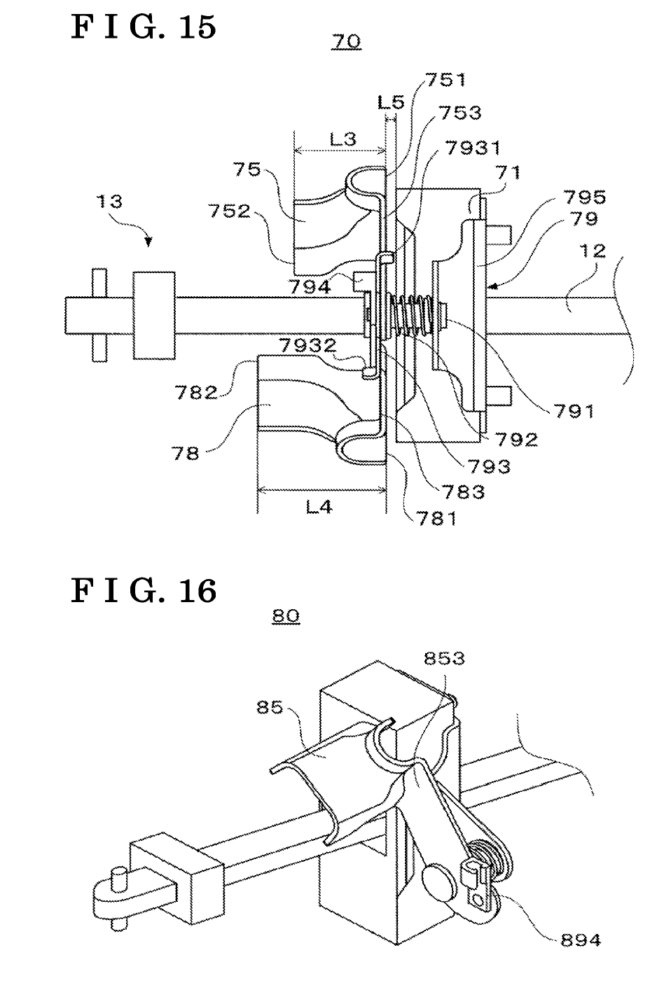

FIG. 13 illustrates the door check mechanism 70. FIG. 14 illustrates a first open degree adjustment block 75, a second open degree adjustment block 78 and a block base 79. FIG. 15 is a side view of the door check mechanism 70. In FIGS. 13 and 15, the illustrations of the vehicle body B, the door D, the bracket 14 and the connection member 16 are omitted for the purpose of simple explanation.

As illustrated in FIG. 13, the door check mechanism 70 includes a door check 71, the check link 12, the stopper portion 13, the bracket 14, the first open degree adjustment block 75, the second open degree adjustment block 78 and the block base 79.

The first open degree adjustment block 75 includes a first contact portion 751 configured to make contact with the door check 71 and a second contact portion 752 which is opposed to the first contact portion 751 while including a predetermined distance L3 (see FIG. 15) from the first contact portion 751 and which is configured to make contact with the stopper portion 13. The first open degree adjustment block 75 further includes an arm portion 753 that is rotatably connected to the block base 79 via a rotary shaft 791. The first open degree adjustment block 75 is thus rotatable about the rotary shaft 791. The first open degree adjustment block 75 is biased in a direction separating from the check link 12 by an arbitrary biasing member such as a torsion coil spring, a plate spring and a rubber member, for example, not illustrated.

The second open degree adjustment block 78 includes a third contact portion 781 configured to make contact with the door check 71 and a fourth contact portion 782 which is opposed to the third contact portion 781 while including a predetermined distance L4 (see FIG. 15) from the third contact portion 781 and which is configured to make contact with the stopper portion 13. The second open degree adjustment block 78 further includes an arm portion 783 that is rotatably connected to the block base 79 via the rotary shaft 791. The second open degree adjustment block 78 is thus rotatable about the rotary shaft 791. The second open degree adjustment block 78 is biased in a direction separating from the check link 12 by an arbitrary biasing member such as a torsion coil spring, a plate spring and a rubber member, for example, not illustrated. The second open degree adjustment block 78 is connected to a position at the rotary shaft 791 so as to be further separated from a base portion 795 of the block base 79, as compared to the first open degree adjustment block 75 at the rotary shaft 791.

The second open degree adjustment block 78 according to the present embodiment is configured so that the distance L4 between the third contact portion 781 and the fourth contact portion 782 is longer than the distance L3 between the first contact portion 751 and the second contact portion 752 of the first open degree adjustment block 75. At this time, alternatively, the second open degree adjustment block may be configured so that the distance L4 is shorter than the distance L3.

The block base 79 includes the rotary shaft 791, a biasing member 792, a link (coupling member) 793, a connection portion 794 and the base portion 795. The base portion 795 of the block base 79 is sandwiched between the door D and the door check 71 and is fixed to the door D. The base portion 795 of the block base 79 extends to the lateral side of the door check 71 to rotatably support the first and second open degree adjustment blocks 75 and 78 at the lateral side of the door check 71 via the rotary shaft 791.

The rotary shaft 791 extends in the longitudinal direction of the check link 12 at the lateral side of the door check 71. Thus, the first open degree adjustment block 75 is rotatable substantially in the up-down direction along a direction indicated by an arrow A5 in FIG. 13 about the rotary shaft 791. The first open degree adjustment block 75 is therefore rotatable in a direction approaching the check like 12 (lower direction) or in a direction separating from the check link 12 (upper direction). In the same manner, the second open degree adjustment block 78 is also rotatable substantially in the up-down direction along a direction indicated by an arrow A6 in FIG. 13 about the rotary shaft 791. The second open degree adjustment block 78 is rotatable in a direction approaching the check like 12 (upper direction) or in a direction separating from the check link 12 (lower direction).

The biasing member 792 may be constituted by an arbitrary biasing member including a spring and a rubber member, for example, provided coaxially with the rotary shaft 791. The biasing member 792 is disposed between the base portion 795 and the arm portion 753 of the first open degree adjustment block 75. Thus, the biasing member 792 biases the first and second open degree adjustment blocks 75 and 78 which are connected to the base portion 795 via the rotary shaft 791 in a direction separating from the base portion 795 in the extending direction of the rotary shaft 791. The base portion 795 is provided at a side where the door check 71 is provided in the extending direction of the rotary shaft 791, i.e., in the longitudinal direction of the check link 12. Thus, the biasing member 792 biases the first and second open degree adjustment blocks 75 and 78 in the direction separating from the door check 71 in the longitudinal direction of the check link 12. Accordingly, a clearance with a length L5 (see FIG. 15) may be defined between the door check 71 and each of the first contact portion 751 of the first open degree adjustment block 75 and the third contact portion 781 of the second open degree adjustment block 78. As a result, the first and second open degree adjustment blocks 75 and 78 may be inhibited from rotating in a state where the first and third contact portions 751 and 781 make contact with the door check 71.

The link 793 is rotatably connected to the rotary shaft 791 via which the link 793 is connected to the arm portion 753 of the first open degree adjustment block 75 and the arm portion 783 of the second open degree adjustment block 78. The connection member 16 is also connected to the link 793 via the connection portion 794. Accordingly, the link 93 is rotatable about the rotary shaft 791 by the movement of the connection member 16 based on the operation of the operation portion not illustrated.

Here, as illustrated in FIG. 14, the link 793 includes a first link contact portion 7931 configured to make contact with the arm portion 753 of the first open degree adjustment block 75 and a second link contact portion 7932 configured to make contact with the arm portion 783 of the second open degree adjustment block 78. Thus, the link 793 may cause the first open degree adjustment block 75 or the second open degree adjustment block 78 to rotate on a basis of the rotation direction of the link 793.

In the present embodiment, when the connection member 16 moves in the upper direction, the link 793 rotates in a counterclockwise direction to thereby rotate the first open degree adjustment block 75 in a counterclockwise direction via the first link contact portion 7931. Accordingly, the first open degree adjustment block 75 is rotatable to a position abutting the check link 12 by rotating in the lower direction. When the connection member 16 moves in the lower direction, the link 793 rotates in a clockwise direction to thereby rotate the second open degree adjustment block 78 in a clockwise direction via the second link contact portion 7932. Accordingly, the second open degree adjustment block 78 is rotatable to a position abutting the check link 12 by rotating in the upper direction.

Next, an operation in a case where the open degree of the door D is restricted by the door check mechanism 70 according to the present embodiment is explained with reference to FIG. 15.

FIG. 15 illustrates the door check mechanism 70 in a case where the open degree of the door D is specified to the full open degree. In this case, the first and second open degree adjustment blocks 75 and 78 are arranged at positions separated from the check link 12. Thus, the stopper portion 13 is movable to a position making contact with the door check 71 based on the rotation of the door D. The door D may open to the fully open degree.

Next, when the user operates the operation portion so as to restrict the open degree of the door D to the first open degree by the first open degree adjustment block 75, the connection member 16 moves in the upper direction based on the operation of the operation portion to thereby rotate the link 793 in the counterclockwise direction. In a case where the link 93 rotates in the counterclockwise direction, the first link contact portion 7931 which makes contact with the first open degree adjustment block 75 causes the first open degree adjustment block 75 to rotate in the counterclockwise direction and to rotate in the lower direction. Accordingly, the first open degree adjustment block 75 rotates in a direction approaching the check link 12 to be arranged between the stopper portion 13 and the door check 71.

At this time, when the door D is opened, the stopper portion 13 moves in the direction of the one end portion of the check link 12 mounted to the vehicle body B to make contact with the second contact portion 752 of the first open degree adjustment block 75. The first open degree adjustment block 75 is arranged at the position away from the door check 71 by the length L5 based on biasing of the biasing member 792. Nevertheless, the first open degree adjustment block 75 moves in a direction in which the biasing member 792 is contracted on a basis of the movement of the stopper portion 13 so that the first contact portion 751 makes contact with the door check 71. Because the door check 71 is mounted to the door D, the door check 71 restricts the movement of the first open degree adjustment block 75 in the direction of the one end portion of the check link 12 mounted to the vehicle body B. The first open degree adjustment block 75 restricts the movements of the check link 12 and the stopper portion 13 in the direction of the one end portion of the check link 12 mounted to the vehicle body B to thereby restrict the rotation of the door D. Thus, the first open degree adjustment block 75 may restrict the open degree of the door D based on the distance disposed between the stopper portion 13 and the door check 71, i.e., the distance L3 between the first contact portion 751 and the second contact portion 752.

In the same manner, in a case where the user operates the operation portion so as to restrict the open degree of the door D to the second open degree by the second open degree adjustment block 78, the connection member 16 moves in the lower direction based on the operation of the operation portion to thereby rotate the link 793 in the clockwise direction. When the link 793 rotates in the clockwise direction, the second link contact portion 7932 which makes contact with the second open degree adjustment block 78 causes the second open degree adjustment block 78 to rotate in the clockwise direction and to rotate in the upper direction. As a result, the second open degree adjustment block 78 rotates in the direction approaching the check link 12 to be arranged between the stopper portion 13 and the door check 71.

At this time, when the door D is opened, the stopper portion 13 moves in the direction of the one end portion of the check link 12 mounted to the vehicle body B and makes contact with the fourth contact portion 782 of the second open degree adjustment block 78. The second open degree adjustment block 78 is also arranged at the position away from the door check 71 by the length L5 based on biasing of the biasing member 792 in the same manner as the first open degree adjustment block 75. The second open degree adjustment block 78 moves in a direction in which the biasing member 792 is contracted with the movement of the stopper portion 13. The third contact portion 781 then makes contact with the door check 71. Accordingly, the door check 71 restricts the movement of the second open degree adjustment block 78 in the direction of the one end portion of the check link 12 mounted to the vehicle body B. The second open degree adjustment block 78 restricts the movements of the check link 12 and the stopper portion 13 in the direction of the one end portion of the check link 12 mounted to the vehicle body B to thereby restrict the rotation of the door D. As a result, the second open degree adjustment block 78 may restrict the open degree of the door D based on the distance disposed between the stopper potion 13 and the door check 71, i.e., the distance L4 between the third contact portion 781 and the fourth contact portion 782.

Accordingly, in the door check mechanism 70 of the present embodiment, the first and second open degree adjustment blocks 75 and 78 are positioned at the lateral side of the door check 71 and are rotatably connected to the rotary shaft 791 which extends in the longitudinal direction of the check link 12. Thus, a space for the rotation of the open degree adjustment block in the up-down direction at the door check mechanism 70 may be reduced as compared to a case where the first and second open degree adjustment blocks rotate about the respective rotary shafts provided at the top portion and the bottom portion of the door check. A space in the rotation direction of the open degree adjustment block required for mounting the door check mechanism may be reduced. In the door check mechanism 70, the open degree of the door D may be restricted in a stepwise manner by the first and second open degree adjustment blocks 75 and 78.

In the door check mechanism 70 of the present embodiment, the biasing member 792 is provided so as to bias the first and second open degree adjustment block 75 and 78 in the direction separating from the door check 71 in the longitudinal direction of the check link 12. Thus, a clearance may be secured between the door check 71 and each of the first contact portion 751 of the first open degree adjustment block 75 and the third contact portion 761 of the second open degree adjustment block 78. As a result, the first and second open degree adjustment blocks 75 and 78 are inhibited from making contact with the door check 71 when rotating, thereby inhibiting generation of friction caused by a possible contact, for example. In the door check mechanism 70 according to the present embodiment, damages or malfunctions, for example, of the first and second open degree adjustment blocks 75, 78 and the door check 71 resulting from friction upon rotation of the first and second open degree adjustment blocks 75 and 78 may be inhibited.

The biasing member 792 may absorb impact generated when the stopper portion 13 makes contact with the first open degree adjustment block 75 or the second open degree adjustment block 78 based on the rotation of the door D. Accordingly, damages of the stopper portion 13 and the first and second open degree adjustment blocks 75, 78 resulting from the impact generated upon contact of the stopper portion 13 relative to the first open degree adjustment block 75 or the second open degree adjustment block 78 may be restrained.

Without the usage of the biasing member 792, the open degree adjustment block or the arm portion thereof may be constituted by an elastic member such as a spring plate, for example, and the first and second open degree adjustment blocks may be biased in the direction separating from the door check 71 in the longitudinal direction of the check link 12. According to such construction, a clearance may be also secured between the door check 71 and each of the first contact portion of the first open degree adjustment block and the third contact portion of the second open degree adjustment block. In addition, damage of the open degree adjustment block in a case where the stopper portion 13 moves the open degree adjustment block towards the door check 71 may be restrained on a basis of an elastic force of the elastic member.

In the door check mechanism 70, the first and second open degree adjustment blocks 75 and 78 are mounted on the same rotary shaft 791 in a state where the second open degree adjustment block 78 is provided closer to the stopper portion 13. When the second open degree adjustment block 78 moves in the direction of the one end portion of the check link 12 mounted to the vehicle body B, i.e., towards the door check 71, by the stopper portion 13, the arm portion 783 also moves towards the door check 71 on the rotary shaft 791. Thus, when the arm portion 783 of the second open degree adjustment block 78 moves, the arm portion 753 of the first open degree adjustment block 75 moves along the rotary shaft 791. As a result, in association with the movement of the second open degree adjustment block 78, the first open degree adjustment block 75 also moves towards the door check 71.

Here, a case where the third contact portion 781 is disposed closer to the stopper portion 13 than the first contact portion 781 in the longitudinal direction of the check link 12 is assumed. In the aforementioned case, along with the movement of the second open degree adjustment block 78 towards the door check 71, the first contact portion 751 of the first open degree adjustment block 75 may make contact with the door check 71 prior to contact of the third contact portion 781 of the first contact portion 751 with the door check 71. As a result, the first open degree adjustment block 75 may restrict the movement of the second open degree adjustment block 78 towards the door check 71, the second open degree adjustment block 78 being provided closer to the stopper portion 13 on the rotary shaft 791. In such case, the second open degree adjustment block 78 is sandwiched between the stopper portion 13 and the door check 71 in an unstable manner, which may inhibit the open degree of the door D from being accurately restricted to a predetermined open degree.

On the other hand, in the door check mechanism 70, the arm portion 783 of the second open degree adjustment block 78 is curved towards the door check 71 in the longitudinal direction of the check link 12 as illustrated in FIGS. 13 and 15. Thus, the first contact portion 751 of the first open degree adjustment block 75 and the third contact portion 781 of the second open degree adjustment block 78 are provided on the same plane. According to such construction, even in a case where the first open degree adjustment block 75 moves towards the door check 71 when the second open degree adjustment block 78 moves towards the door check 71, the third contact portion 781 is contactable with the door check 71. Thus, the first open degree adjustment block 75 is inhibited from restricting the movement of the second open degree adjustment block 78 which is arranged closer to the stopper portion 13 on the rotary shaft 791, towards the door check 71.

In the present embodiment, the first open degree adjustment block 75 is arranged in the upper direction relative to the check link 12. The first open degree adjustment block 75 rotates in the lower direction to approach the check link 12. On the other hand, the second open degree adjustment block 78 is arranged in the lower direction relative to the check link 12. The second open degree adjustment block 78 rotates in the upper direction to approach the check link 12. At this time, the arrangement and rotation direction of the open degree adjustment block are not limited to the above. The open degree adjustment block is at least movable to a position between the door check 71 and the stopper portion 13, i.e., the position abutting the check link 12, by rotating. Therefore, the arrangement and the rotation direction of the open degree adjustment block may be specified at arbitrary position and direction as long as the open degree adjustment block is movable to the position abutting the check link 12 by the rotation of the open degree adjustment block. For example, the open degree adjustment block may be configured to rotate towards the check link 12 from the lateral side of the check link 12 or from an oblique position relative to the check link 12. Thus, the block base may be configured so that the rotary shaft of the open degree adjustment block is positioned at the upper or lower side, or at the oblique position of the door check 71.

In the door check mechanism 70, the base portion 795 serving as a separate member from the door check 71 is sandwiched between the door check 71 and the door D and is fixed to the door D. At this time, the construction of the base portion 795 is not limited to the above. The base portion of the block base serving as the separate member from the door check 71 may be directly fixed to the door D by means of an arbitrary fixing means or integrally constituted with the door check 71.

In the present embodiment, the link 793 is connected to the rotary shaft 791 in a state being sandwiched between the arm portion 753 of the first open degree adjustment block 75 and the arm portion 783 of the second open degree adjustment block 78. At this time, the construction of the link 793 is not limited to the above. For example, the link 793 may be provided closer to the door check 71 or closer to the stopper portion 13 in the longitudinal direction of the check link 12 as compared to the first and second open degree adjustment blocks 75 and 78. In this case, the first and second link contact portions 7931 and 7932 extend in the same direction in the longitudinal direction of the check link 12. At this time, when one of the open degree adjustment blocks rotates on a basis of the rotation direction of the link, the link contact portion which makes contact with the arm portion of the other of the open degree adjustment blocks rotates in a direction separating from the other of the open degree adjustment blocks. Thus, even in such case, the link may cause only one of the open degree adjustment blocks to rotate in the direction approaching the check link 12 based on the operation of the operation portion.

In the door check mechanism 70, the connection member 16 is connected to the link 793 via the connection portion 794. Alternatively, the connection member 16 may be directly connected to the link 793.

In addition, the single open degree adjustment block may be employed. A door check mechanism 80 in such case is explained with reference to FIG. 16. FIG. 16 illustrates the door check mechanism 80 according to a modified example of the present embodiment.

The door check mechanism 80 includes the same construction as the door check mechanism 70 except that the door check mechanism 80 includes a single open degree adjustment block 85. In this case, the link 793 for operating the two open degree adjustment blocks by the single connection member 16 is not necessary. Thus, as illustrated in FIG. 16, the connection member 16 is connectable to an arm portion 853 of the open degree adjustment block 85. At this time, the connection member 16 is connected to the arm portion 853 via a connection portion 894. Alternatively, the connection member 16 may be directly connected to the arm portion 853.

### Sixth Embodiment

In the third embodiment, the first open degree adjustment block 15 and the second open degree adjustment block 58 which is disposed between the first open degree adjustment block 15 and the stopper portion 13 are connected to the respective operation portions not illustrated by the two connection members 16 and 56. In a door check mechanism 90 according to a sixth embodiment, the first open degree adjustment block and the second open degree adjustment block move on a basis of the operation of the operation portion by the single connection member.

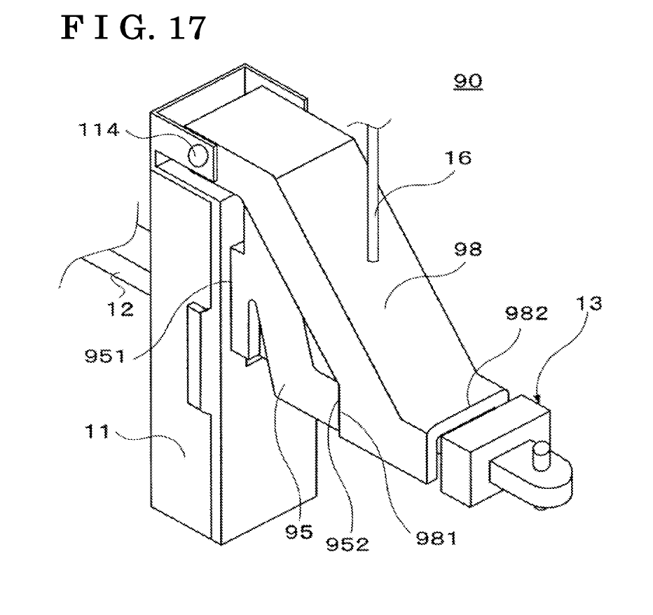

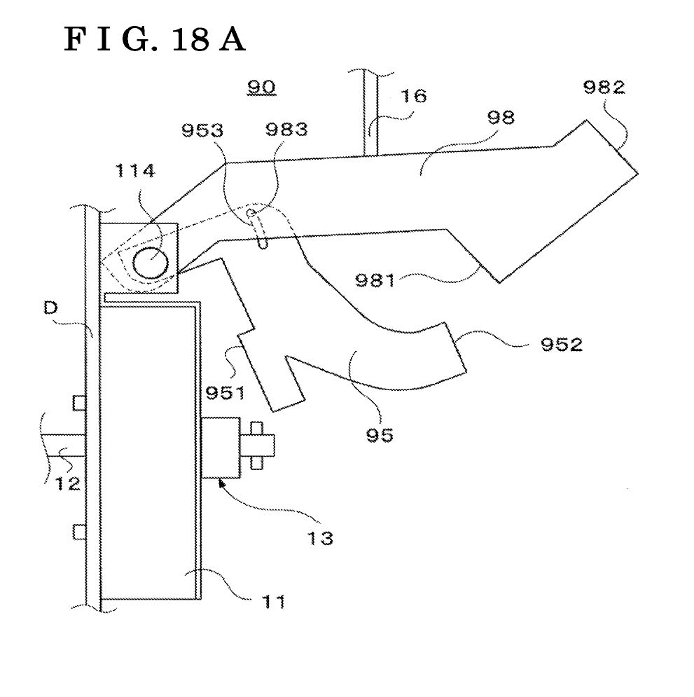

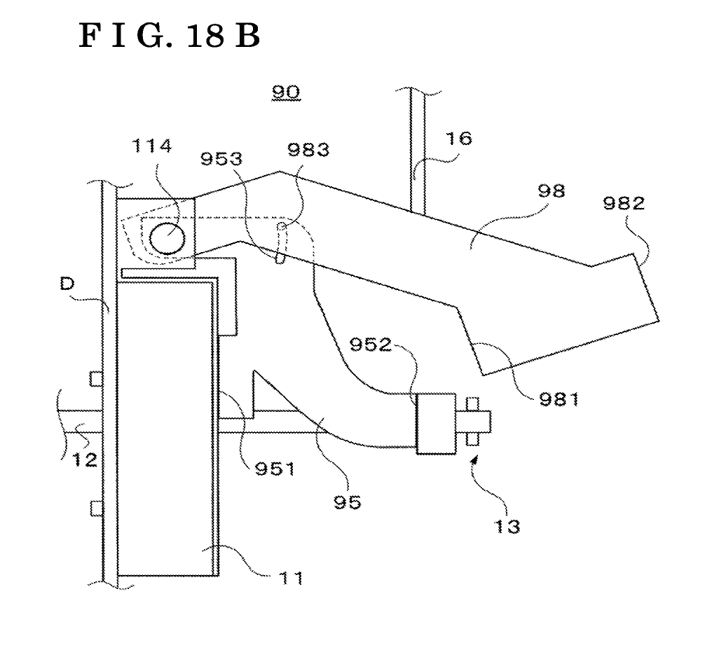

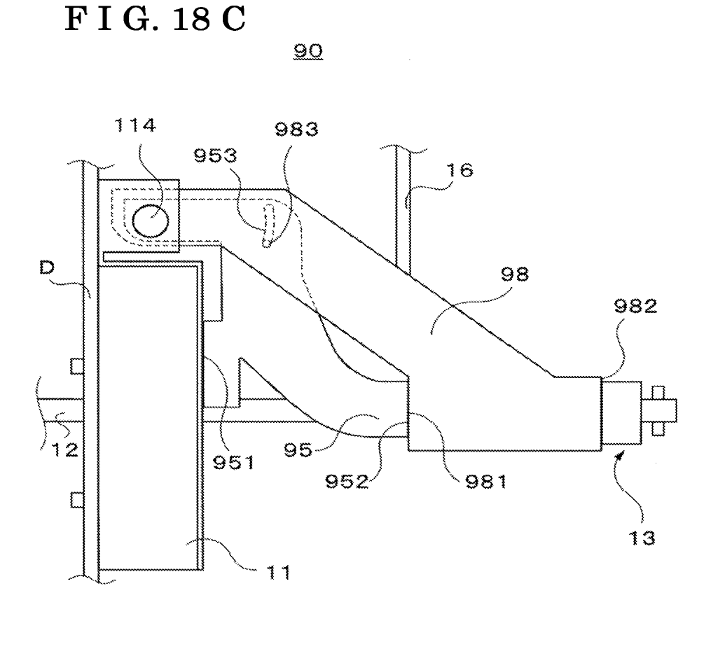

The door check mechanism 90 according to the present embodiment is explained with reference to FIGS. 17, 18A, 18B and 18C. The operation for restricting the open degree of the door D by the open degree adjustment block, for example, is the same as the door check mechanism 50 according to the third embodiment. Thus, differences are mainly explained.

FIG. 17 illustrates the door check mechanism 90 according to the present embodiment. In FIG. 17, the illustrations of the vehicle body B, the door D and the bracket 14 are omitted for the purpose of simple explanation.

The door check mechanism 90 includes the door check 11, the check link 12, the stopper portion 13, the bracket 14, a first open degree adjustment block 95 and a second open degree adjustment block 98. The door check in the door check mechanism 90 is the same as the door check 11 in the door check mechanism 10 according to the first embodiment. Thus, the same reference numeral is assigned and explanation is omitted.

The first open degree adjustment block 95 includes a first contact portion 951 configured to make contact with the door check 11 and a second contact portion 952 configured to make contact with the stopper portion 13. The second contact portion 952 is configured to be opposed to the first contact portion 951 and to include a predetermined distance from the first contact portion 951. The first open degree adjustment block 95 is rotatably connected to the rotary shaft 114 provided at the door check 11. The first open degree adjustment block 95 is biased in a direction approaching the check link 12 by an arbitrary biasing member such as a torsion coil spring, a plate spring and a rubber member, for example, not illustrated.

The second open degree adjustment block 98 includes a third contact portion 981 configured to make contact with the second contact portion 952 of the first open degree adjustment block 95 and a fourth contact portion 982 configured to make contact with the stopper portion 13. The fourth contact portion 982 is configured to be opposed to the third contact portion 981 and to include a predetermined distance from the third contact portion 981. The second open degree adjustment block 98 is also rotatably connected to the rotary shaft 114 provided at the door check 11. The second open degree adjustment block 98 is biased in a direction approaching the check link 12 by an arbitrary biasing member such as a torsion coil spring, a plate spring and a rubber member, for example, not illustrated.

The second open degree adjustment block 98 is connected to the rotary shaft 114 so as to cover the first open degree adjustment block 95. The connection member 16 connected to the operation portion, not illustrated, is connected to the second open degree adjustment block 98. Accordingly, the second open degree adjustment block 98 is rotatable on a basis of the operation of the operation portion by the user.

Further, the first open degree adjustment block 95 includes an elongated bore portion (connection portion) 953 extending by a predetermined distance along a rotation direction of the second open degree adjustment block 98 about the rotary shaft 114 as illustrated in FIGS. 18A to 18C. In addition, the second open degree adjustment block 98 includes a protruding portion (connection portion) 983 which engages with the elongated bore portion 953. The protruding portion 983 extends within the elongated bore portion 953 to engage with the elongated bore portion 953.

Next, operations of the first and second open degree adjustment blocks 95 and 98 in the door check mechanism 90 are explained with reference to FIGS. 18A to 18C. FIGS. 18A to 18C illustrate the operations of the door check mechanism 90. FIG. 18A illustrates the door check mechanism 90 in a case where the door D is at the full open degree. FIG. 18B illustrates the door check mechanism 90 in a case where the open degree of the door D is specified to the first open degree by the first open degree adjustment block 95. FIG. 18C illustrates the door check mechanism 90 in a case where the open degree of the door D is specified to the second open degree by the first and second open degree adjustment blocks 95 and 98.

In a case where the open degree of the door D is specified to the full open degree, the connection member 16 brings the second open degree adjustment block 98 to rotate in the upper direction as illustrated in FIG. 18A so that the second open degree adjustment block 98 is arranged at a position away from the door check 11. At this time, the protruding portion 983 of the second open degree adjustment block 98 makes contact with an upper end portion of the elongated bore portion 953 of the first open degree adjustment block 95. Thus, the first open degree adjustment block 95 rotates in accordance with the rotation of the second open degree adjustment block 98 to be arranged at a position away from the door check 11. At this time, when the door D is opened, the stopper portion 13 is movable to the door check 11 in the direction of the one end portion of the check link 12 mounted to the vehicle body B. The door D thus may open at the full open degree.

Next, in a case where the open degree of the door D is specified to the first open degree based on the operation by the user, the second open degree adjustment block 98 rotates in the lower direction as illustrated in FIG. 18B with the movement of the connection member 16 connected to the operation portion. At this time, the first open degree adjustment block 95 is biased in the direction approaching the check link 12 by the biasing member not illustrated. Nevertheless, because the protruding portion 983 of the second open degree adjustment block 98 makes contact with the upper end portion of the elongated bore portion 953 of the first open degree adjustment block 95, the first open degree adjustment block 95 rotates in the lower direction with the rotation of the second open degree adjustment block 98. When the first open degree adjustment block 95 rotates in the lower direction, the first contact portion 951 makes contact with the door check 11. The second contact portion 952 is then arranged at a position facing the stopper portion 13. Thus, the door check 11 restricts the first open degree adjustment block 95 from moving in the direction of the one end portion of the check link 12 mounted to the vehicle body B. On the other hand, the second open degree adjustment block 98 is inhibited from rotating to a position abutting the check link 12 and is disposed at a position not making contact with the stopper portion 13. At this time, when the door D is opened, the stopper portion 13 moves in the direction of the one end portion of the check link 12 mounted to the vehicle body B and makes contact with the second contact portion 952. Accordingly, the first open degree adjustment block 95 restricts the movements of the door check 11 and the stopper portion 13 based on the distance between the first contact portion 951 and the second contact portion 952. Accordingly, the open degree of the door D may be restricted to the first open degree by the first open degree adjustment block 95 based on a length between the first contact portion 951 and the second contact portion 952.

In a case where the open degree of the door D is specified to the second open degree based on the operation by the user, the second open degree adjustment block 98 rotates in the lower direction with the movement of the connection member 16 connected to the operation portion as illustrated in FIG. 18C. At this time, the first open degree adjustment block 95, which makes contact with the door check 11, is inhibited from rotating any more in the lower direction. Thus, the protruding portion 983 separates from the upper end portion of the elongated bore portion 953 with which the protruding portion 983 makes contact and moves along the configuration of the elongated bore portion 953 within the elongated bore portion 953. Accordingly, in this case, only the second open degree adjustment block 98 moves in the lower direction with the movement of the connection member 16. The second open degree adjustment block 98 is arranged at a position where the third contact portion 981 makes contact with the second contact portion 952 of the first open degree adjustment block 95 and the fourth contact portion 982 faces the stopper portion 13.

Because the third contact portion 981 makes contact with the second contact portion 952, the door check 11 restricts the second open degree adjustment block 98 from moving in the direction of the one end portion of the check link 12 mounted to the vehicle body B via the first open degree adjustment block 95. At this time, when the door D is opened, the stopper portion 13 moves in the direction of the one end portion of the check link 12 mounted to the vehicle body B and makes contact with the fourth contact portion 982. As a result, the first and second open degree adjustment blocks 95 and 98 restrict the movements of the door check 11 and the stopper portion 13 based on the length between the first contact portion 951 and the second contact portion 952 and the length between the third contact portion 981 and the fourth contact portion 982. The open degree of the door D may be restricted by the first and second open degree adjustment blocks 95 and 98 to the second open degree based on the length between the first contact portion 951 and the second contact portion 952 and the length between the third contact portion 981 and the fourth contact portion 982.

When the open degree of the door D is specified to the first open degree in a state where the open degree of the door D is specified to the second open degree, the second open degree adjustment block 98 rotates in the upper direction based on the operation of the operation portion. In this case, the protruding portion 983 also moves within the elongated bore portion 953 along the configuration of the elongated bore portion 953. The first open degree adjustment block 95 is inhibited from rotating and only the second open degree adjustment block 98 rotates. The second open degree adjustment block 98 only moves to a position away from the check link 12 while the first open degree adjustment block 95 is arranged at a position abutting the check link 12. The open degree of the door D may be thus specified to the first open degree.

In a case where the open degree of the door D at the first open degree is specified to the full open degree, an inverse operation from the operation for specifying the open degree of the door D at the full open degree to the first open degree is performed. Thus, explanation is omitted.

As mentioned above, according to the door check mechanism 90 of the present embodiment, in order to connect the first and second open degree adjustment blocks 95 and 98 each other, the elongated bore portion and the protruding portion are further provided at the first and second open degree adjustment blocks 95 and 98. Accordingly, with the single connection member 16, the first and second open degree adjustment blocks 95 and 98 are movable on a basis of the operation of the operation portion. In addition, in the same manner as the first open degree adjustment block 95, the second open degree adjustment block 98 also moves towards the check link 12 by rotation to thereby inhibit a positioning error of the second open degree adjustment block 98 relative to the check link 12 resulting from the aforementioned movement of the second open degree adjustment block 98.

The elongated bore portion 953 is provided at the first open degree adjustment block 95 and the protruding portion 983 is provided at the second open degree adjustment block 98 as the connection portions connecting the first and second open degree adjustment blocks 95 and 98 each other. Alternatively, the protruding portion may be provided at the first open degree adjustment block and the elongated bore portion may be provided at the second open degree adjustment block. In this case, the first open degree adjustment block moves while the protruding portion of the first open degree adjustment block makes contact with a lower end portion of the elongated bore portion of the second open degree adjustment block. The extending direction of the elongated bore portion may be specified in an arbitrary direction depending on the rotation direction of the open degree adjustment block. Thus, the end portion of the elongated bore portion with which the protruding portion makes contact may be provided in an arbitrary direction depending on the extending direction of the elongated bore portion, for example.

In addition, the first and second open degree adjustment blocks 95 and 98 may include protruding portions. Then, a coupling member such as a link including elongated bore portions which conform to the aforementioned protruding portions and which are connected to the first and second open degree adjustment blocks 95 and 98 via the elongated bore portions may be employed. At this time, the protruding portions may be integrally provided at the first and second open degree adjustment blocks or may be constituted by other members such as pins.

In the present embodiment, the second open degree adjustment block 98 is also connected to the rotary shaft 114 to rotate about the rotary shaft 114. Thus, the positioning error when the second open degree adjustment block 98 moves to the position abutting the check link 12, for example, may be inhibited. The rotary shaft of the first open degree adjustment block 95 and the rotary shaft of the second open degree adjustment block may be different from each other. At this time, however, because the second open degree adjustment block of the present embodiment is configured to cover the first open degree adjustment block, the rotation directions of the first and second open degree adjustment blocks are the same. The rotation directions of the first and second open degree adjustment blocks may be specified so that the first and second open degree adjustment blocks are rotatable while being sandwiched between the door check 11 and the stopper portion 13. Thus, the rotation directions of the first and second open degree adjustment blocks may be specified in arbitrary directions as long as the rotation directions of the first and second open degree adjustment blocks are the same as each other.

### Seventh Embodiment

In the door check mechanism according to the second to sixth embodiments, the open degree of the door D is restricted in a stepwise manner by the two open degree adjustment blocks. In the door check mechanism according to a seventh embodiment, the single open degree adjustment block is utilized to restrict the open degree of the door D in a stepwise manner.

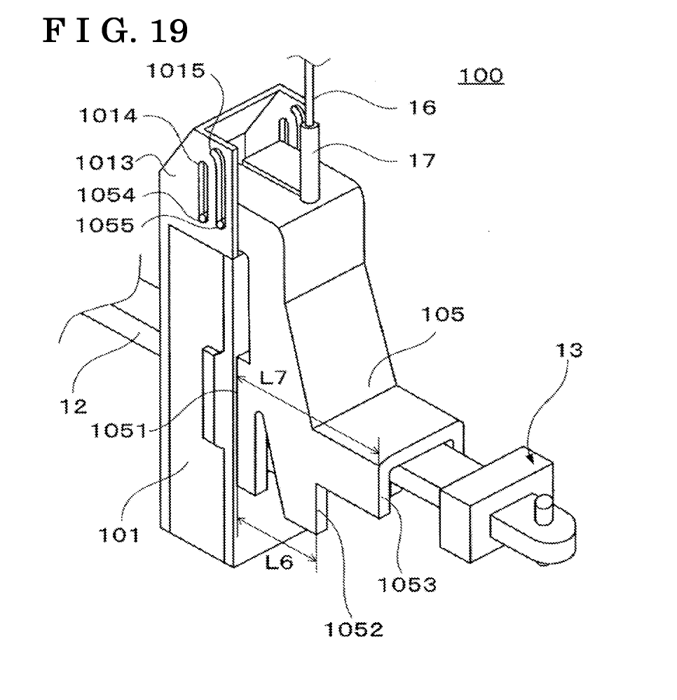

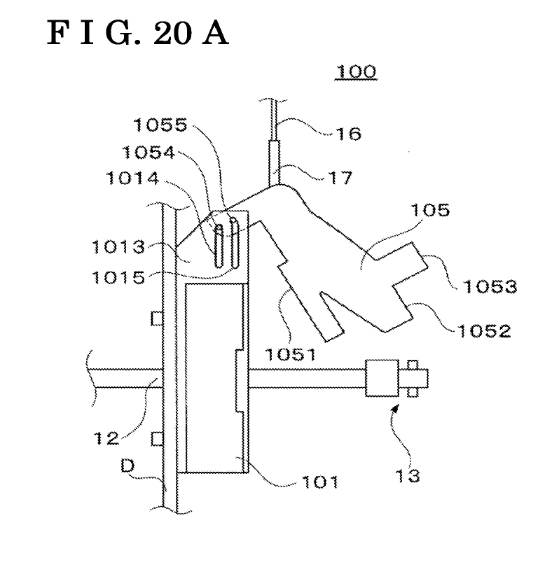

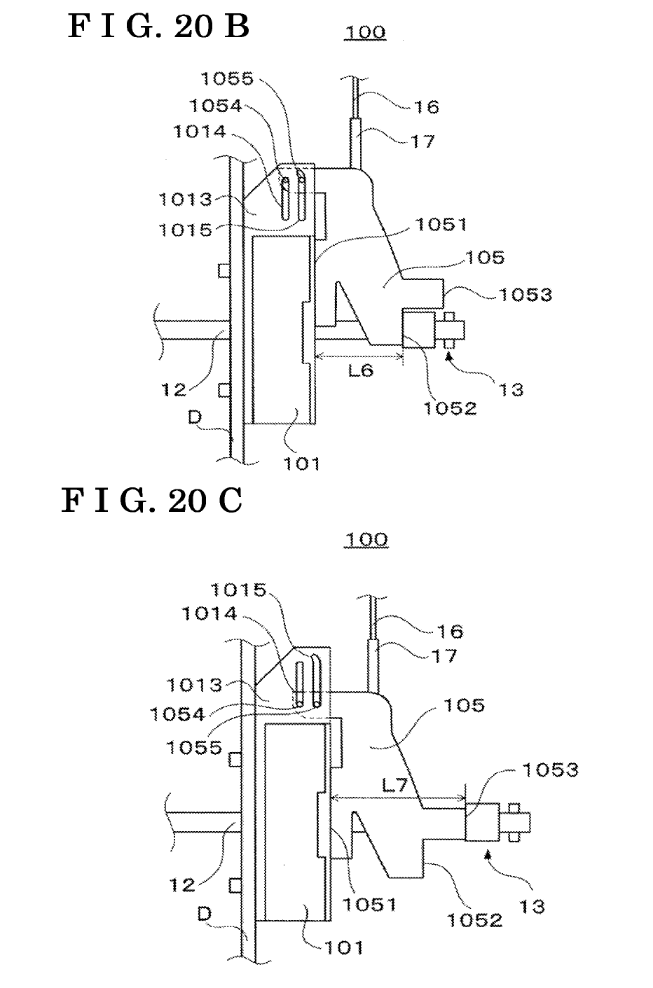

A door check mechanism 100 according to the present embodiment is explained with reference to FIGS. 19, 20A, 20B and 20C. The operation for restricting the open degree of the door D by the open degree adjustment block is the same as the door check mechanism 10 according to the first embodiment, for example. Thus, differences are mainly explained.

FIG. 19 illustrates the door check mechanism 100 according to the present embodiment. In FIG. 19, the illustrations of the vehicle body B, the door D and the bracket 14 are omitted for the purpose of simple explanation.

The door check mechanism 100 includes a door check 101, the check link 12, the stopper portion 13, the bracket 14 and an open degree adjustment block 105.

The door check 101 is mounted to the door D. A guide member 1013 is provided at a top portion of the door check 101. A first elongated bore portion (guide portion) 1014 which extends in the up-down direction is provided at the guide member 1013. A second elongated bore portion (guide portion) 1015 is also provided at the guide member 1013 so as to be arranged at a position separated from the first elongated bore portion 1014 by a predetermined distance. The second elongated bore portion 1015 which extends in the up-down direction includes a curving portion at an upper portion, the curving portion curving by a predetermined distance along a circle with reference to an upper end portion of the first elongated bore portion 1014.

The open degree adjustment block 105 includes a first contact portion 1051 configured to make contact with the door check 101, a second contact portion 1052 and a third contact portion 1053 both of which are configured to make contact with the stopper portion 13. The second contact portion 1052 is opposed to the first contact portion 1051 while including a predetermined distance L6 from the first contact portion 1051. The third contact portion 1053 is opposed to the first contact portion 1051 while including a predetermined distance L7 from the first contact portion 1051.

The open degree adjustment block 105 further includes a first protruding portion 1054 which extends within the first elongated bore portion (guide portion) 1014 and a second protruding portion (guide portion) 1055 which extends within the second elongated bore portion 1015. The connection member 16 is connected to the open degree adjustment block 105 via the biasing member 17 constituted by an arbitrary elastic member such as a spring and a rubber member, for example. The connection member 16 is connected to the operation portion not illustrated. Thus, the open degree adjustment block 105 moves with the movement of the connection member 16 based on the operation of the operation portion by the user. The biasing member 17 biases the open degree adjustment block 105 towards the check link 12.

The second contact portion 1052 and the third contact portion 1053 of the open degree adjustment block 105 are constituted in a stepwise manner so that the distance L7 between the first contact portion 1051 and the third contact portion 1053 is longer than the distance L6 between the first contact portion 1051 and the second contact portion 1052. The second contact portion 1052 is provided at a closer position to the check link 12 as compared to the third contact portion 1053 in a case where the open degree of the door D is specified to the full open degree and the open degree adjustment block 105 is disposed at a position away from the check link 12. Thus, in the open degree adjustment block 105 according to the present embodiment, the second contact portion 1052 is provide at the upper side than the third contact portion 1053. In the present embodiment, the third contact portion 1053 is provided so that the distance L7 is longer than the distance L6. Alternatively, the third contact portion 1053 may be provided so that the distance L7 is shorter than the distance L6.

Next, an operation of the open degree adjustment block 105 in the door check mechanism 100 is explained with reference to FIGS. 20A, 20B and 20C. FIG. 20A illustrates the door check mechanism 100 in a case where the open degree of the door D is specified to the full open degree. FIG. 20B illustrates the door check mechanism 100 in a case where the open degree of the door D is specified to the first open degree corresponding to the distance L6 between the first contact portion 1051 and the second contact portion 1052. FIG. 20C illustrates the door check mechanism 100 in a case where the open degree of the door D is specified to the second open degree corresponding to the distance L7 between the first contact portion 1051 and the third contact portion 1053.

When the open degree of the door D is specified to the full open degree, the connection member 16 is moved in the upper direction as illustrated in FIG. 20A based on the operation of the operation portion not illustrated. The open degree adjustment block 105 is arranged at the position away from the check link 12 based on the position of the connection member 16.

With the aforementioned position of the open degree adjustment block 105, the first and second protruding portions 1054 and 1055 are arranged at respective positions away from the check link 12 along configurations of the first and second elongated bore portions 1014 and 1015. Specifically, the first protruding portion 1054 makes contact with an upper end portion of the first elongated bore portion 1014. The open degree adjustment block 105 rotates in a direction separating from the check link 12 about the first protruding portion 1054 which makes contact with the first elongated bore portion 1014. The upper portion of the second elongated bore portion 1015, i.e., a portion away from the check link 12, is formed along the circle with reference to the upper end portion of the first elongated bore portion 1014. Thus, the second protruding portion 1055 may move along the configuration of the second elongated bore portion 1015 in a case where the open degree adjustment block 105 rotates to thereby guide the rotation of the open degree adjustment block 105.

Accordingly, in a case where the open degree adjustment block 105 rotates in the direction separating from the check link 12 at the position at which the open degree adjustment block 15 is away from the check link 12, the stopper portion 13 is movable to a position making contact with the door check 101 depending on the rotation of the door D. The door D may thus open to the full open degree.

Next, a case where the user operates the operation portion so as to specify the open degree of the door D to the first open degree corresponding to the distance L6 between the first contact portion 1051 and the second contact portion 1052 is explained. In this case, as illustrated in FIG. 20B, the connection member 16 is moved in the lower direction based on the operation of the operation portion and the open degree adjustment block 105 is arranged at the position rotated towards the check link 12. In a case where the open degree adjustment block 105 rotates towards the check link 12, the first protruding portion 1054 makes contact with the upper end portion of the first elongated bore portion 1014 and the open degree adjustment block 105 rotates towards the check link 12 about the first protruding portion 1054. In this case, the second protruding portion 1055 moves along the configuration of the second elongated bore portion 1015 so as to guide the rotation of the open degree adjustment block 105 towards the check link 12.

In a case where the open degree adjustment block 105 rotates towards the check link 12, the first contact portion 1051 makes contact with the door check 101. The door check 101 restricts the open degree adjustment block 105 from moving in the direction of the one end portion of the check link 12 mounted to the vehicle body B. The second contact portion 1052 is provided being opposed to the first contact portion 1051. The second contact portion 1052 is arranged at the position closer to the check link 12 as compared to the third contact portion 1053 in a case where the open degree adjustment block 105 is arranged at the position away from the check link 12. Thus, when the open degree adjustment block 105 rotates towards the check link 12, the second contact portion 1052 faces the stopper portion 13 which is configured to make contact with the door check 101. Accordingly, when the door D is opened in a case where the open degree adjustment block 105 is arranged at a position at which the second contact portion 1052 faces the stopper portion 13, the check link 12 moves in the direction of the one end portion mounted to the vehicle body B, which brings the stopper portion 13 to make contact with the second contact portion 1052. Accordingly, the open degree adjustment block 105 restricts the check link 12 and the stopper portion 13 from moving in the direction of the one end portion mounted to the vehicle body B based on the distance L6 between the first contact portion 1051 and the second contact portion 1052. That is, the open degree adjustment block 105 may restrict the open degree of the door D to the first open degree.

Next, a case where the user operates the operation portion to specify the open degree of the door D to the second open degree corresponding to the distance L7 between the first contact portion 1051 and the third contact portion 1053 is explained. In this case, as illustrated in FIG. 20C, the connection member 16 is moved in the lower direction based on the operation of the operation portion and the open degree adjustment block 105 is arranged at a position slid towards the check link 12. In a case where the open degree adjustment block 105 slides towards the check link 12, the first and second protruding portions 1054 and 1055 move along the configurations of the first and second elongated bore portions 1014 and 1015. As a result, the first and second protruding portions 1054 and 1055 may guide the sliding of the open degree adjustment block 105.

The open degree adjustment block 105 slides towards the check link 12 with the movement of the connection member 16 to be arranged at a position at which the third contact portion 1053 faces the stopper portion 13. At this time, as mentioned above, the door check 101 makes contact with the first contact portion 1051 so as to restrict the open degree adjustment block 105 from moving in the direction of the one end portion of the check link 12 mounted to the vehicle body B. When the door D is opened in a case where the open degree adjustment block 105 is arranged at the aforementioned position, the check link 12 moves in the direction of the one end portion of the check link 12 mounted to the vehicle body B so that the stopper portion 13 makes contact with the third contact portion 1053. Thus, the open degree adjustment block 105 may restrict the movements of the check link 12 and the stopper portion 13 in the direction of the one end portion of the check link 12 mounted to the vehicle body B based on the distance L7 between the first contact portion 1051 and the third contact portion 1053. That is, the open degree adjustment block 105 may restrict the open degree of the door D to the second open degree.

In a case where the open degree of the door D is specified to the first open degree from the second open degree, being opposite from the aforementioned operation, the open degree adjustment block 105 slides in the upper direction to a position at which the second contact portion 1052 faces the stopper portion 13 in accordance with the movement of the connection member 16 based on the operation of the operation portion. In a case where the open degree of the door D is specified to the full open degree from the first open degree, the open degree adjustment block 105 rotates in a direction separating from the check link 12 (in the upper direction) about the first protruding portion 1054 in accordance with the movement of the connection member 16 based on the operation of the operation portion.

As mentioned above, in the door check mechanism 100 of the present embodiment, the open degree adjustment block 105 includes the third contact portion 1053 opposed to the first contact portion 1051 and configured to face the stopper portion 13 while including the predetermined distance L7 from the first contact portion 1051 in the longitudinal direction of the check link 12. The third contact portion 1053 is provided so that the distance L7 between the first contact portion 1051 and the third contact portion 1053 is longer than the distance L6 between the first contact portion 1051 and the second contact portion 1052.

The open degree adjustment block 105 includes the first protruding portion 1054 serving as a rotary center upon rotation relative to the check link 12 and guiding the sliding of the open degree adjustment block 105 after the open degree adjustment block 105 rotates towards the check link 12. The open degree adjustment block 105 may restrict the check link 12 from moving in the direction of the one end portion of the check link 12 based on the distance L7 in a case where the open degree adjustment block 105 slides towards the check link 12 so that the stopper portion 13 makes contact with the third contact portion 1053.

Accordingly, the sliding of the open degree adjustment block 105 relative to the check link 12 may cause the second contact portion 1052 or the third contact portion 1053 to selectively face the stopper portion 13 to selectively restrict the open degree of the door D. Thus, the open degree of the door D may be restricted in a two-step manner by the single open degree adjustment block 105. Further, the open degree adjustment block 105 may include the second protruding portion 1055 at a position away from the first protruding portion 1054 by a predetermined distance for guiding the rotation and sliding of the open degree adjustment block 105 relative to the check link 12. In this case, a positioning error of the open degree adjustment block 105 relative to the check link 12 or the door check 101 upon rotation and sliding of the open degree adjustment block 105 may be further restrained.

According to the present embodiment, the first protruding portion 1054 is employed as a first guide portion functioning as the rotary center of the open degree adjustment block 105 and guiding the sliding of the open degree adjustment block 105 and the second protruding portion 1055 is employed as a second guide portion guiding the rotation and sliding of the open degree adjustment block 105. Nevertheless, the constructions of the first and second guide portions are not limited to the above. For example, the guide member 1013 mounted to the door check 101 may include first and second protruding portions and the open degree adjustment block may include first and second elongated bore portions conforming to the first and second protruding portions. In this case, the first and second elongated bore portions of the open degree adjustment block function as the first and second guide portions. In this case, a curving portion curving along a circle with reference to a lower end portion of the first elongated bore portion is provided at a lower portion of the second elongated bore portion serving as the second guide portion. The first and second protruding portions may be integrally provided at the open degree adjustment block or the guide member or may be obtained as arbitrary separate members such as pins, for example.

The open degree adjustment block 105 includes the two contact portions constituted by the second and third contact portions 1052 and 1053 as the contact portions each of which is opposed to the first contact portion 1051 and each of which is configured to make contact with the stopper portion 13. At this time, the number of contact portions opposed to the first contact portion 1051 and configured to make contact with the stopper portion 13 is not limited to two. Three or more of the aforementioned contact portions may be provided. In this case, the open degree adjustment block 105 may restrict the open degree of the door D in a stepwise manner depending on a distance between the first contact portion 1051 and each of the contact portions which is configured to make contact with the stopper portion 13.

In the door check mechanism 100 according to the present embodiment, the open degree adjustment block 105 rotates and slides in the up-down direction. At this time, the moving direction of the open degree adjustment block 105 is not limited to the above. At least the open degree adjustment block may be arranged between the door check 101 and the stopper portion 13 by the rotation and sliding. Thus, the open degree adjustment block may be configured to rotate and slide in an arbitrary direction relative to the check link 12. For example, the open degree adjustment block may be provided at a lateral portion of the door check 101 so as to rotate and slide in a left-right direction relative to the door check 101. The first and second elongated bore portions of the guide portions functioning as the guide portions and the first and second protruding portions of the open degree adjustment block functioning as the guide portions may be provided in arbitrary directions depending on the rotation direction and sliding direction of the open degree adjustment block.

### Eighth Embodiment

In the door check mechanism 100 according to the seventh embodiment, the open degree of the door D is restricted in a stepwise manner by the single open degree adjustment block 105 which rotates and slides. On the other hand, in the door check mechanism according to an eighth embodiment, the open degree of the door D is restricted in a stepwise manner by the single open degree adjustment block which rotates.

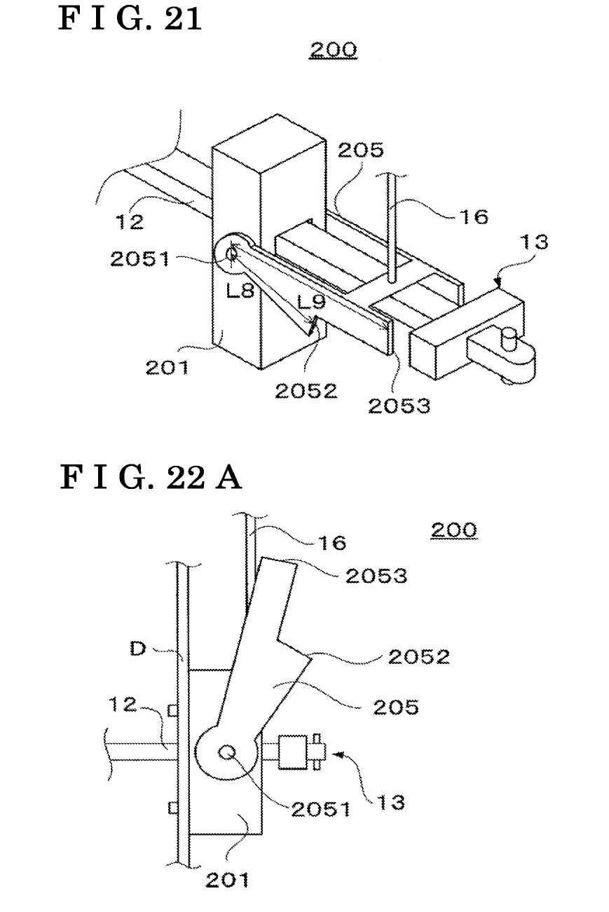

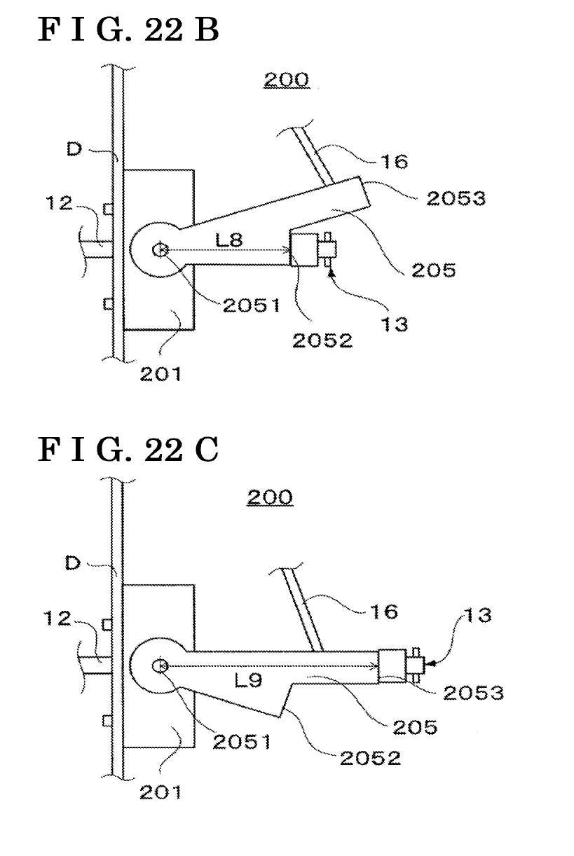

A door check mechanism 200 according to the present embodiment is explained with reference to FIGS. 21, 22A, 22B and 22C. An operation for restricting the open degree of the door D by the open degree adjustment block, for example, is the same as the door check mechanism 10 according to the first embodiment, for example, and thus differences are mainly explained.

FIG. 21 illustrates the door check mechanism 200 according to the present embodiment. In FIG. 21, the illustrations of the vehicle body B, the door D and the bracket 14 are omitted for the purpose of simple explanation.

The door check mechanism 200 includes a door check 201, the check link 12, the stopper portion 13, the bracket 14 and an open degree adjustment block 205.

The door check 201 is mounted to the door D. A first contact portion 2051 of the open degree adjustment block 205 is rotatably connected to a lateral portion in a portion of the door check 201 through which the check link 12 passes to be positioned.

The open degree adjustment block 205 includes the first contact portion 2051 configured to make contact with the door check 201, a second contact portion 2052 and a third contact portion 2053 which are configured to make contact with the stopper portion 13. The first contact portion 2051 is rotatably connected to the lateral portion in the portion of the door check 201 through which the check link 12 passes to make contact with a bore portion (not illustrated) of the door check 201 which receives the first contact portion 2051.

The connection member 16 connected to the operation portion not illustrated is connected to the open degree adjustment block 205. The open degree adjustment block 205 rotates about the first contact portion 2051 in accordance with the movement of the connection member 16 based on the operation of the operation portion.

The second contact portion 2052 of the open degree adjustment block 205 is configured to be opposed to the first contact portion 2051 and to include a predetermined distance L8 from the first contact portion 2051. The third contact portion 2053 is also configured to be opposed to the first contact portion 2051 and to include a predetermined distance L9 from the first contact portion 2051. In the present embodiment, the third contact portion 2053 is provided so that the distance L9 is longer than the distance L8. Alternatively, the third contact portion 2053 may be provided so that the distance L9 is shorter than the distance L8.

Next, an operation of the open degree adjustment block 205 in the door check mechanism 200 is explained with reference to FIGS. 22A to 22C. FIG. 22A illustrates the door check mechanism 200 in a case where the open degree of the door D is specified to the full open degree. FIG. 22B illustrates the door check mechanism 100 in a case where the open degree of the door D is specified to the first open degree corresponding to the distance L8 between the first contact portion 2051 and the second contact portion 2052. FIG. 22C illustrates the door check mechanism 200 in a case where the open degree of the door D is specified to the second open degree corresponding to the distance L9 between the first contact portion 2051 and the third contact portion 2053.

In a case where the open degree of the door D is specified to the full open degree, the connection member 16 is moved in the upper direction as illustrated in FIG. 22A based on the operation of the operation portion not illustrated. The open degree adjustment block 205 is rotated to the upper side about the first contact portion 2051 based on the position of the connection member 16. Accordingly, the second contact portion 2052 and the third contact portion 2053 of the open degree adjustment block 205 are moved in directions separated from the check link 12, so that the stopper portion 13 is movable to a position making contact with the door check 101 based on the rotation of the door D. The door D may therefore open to the full open degree.

Next, a case where the user operates the operation portion to specify the open degree of the door D to the first open degree corresponding to the distance L8 between the first contact portion 2051 and the second contact portion 2052 is explained. In this case, as illustrated in FIG. 22B, the connection member 16 is moved in the lower direction based on the operation of the operation portion and the open degree adjustment block 205 is rotated to the lower side about the first contact portion 2051 of the open degree adjustment block 205.

At this time, the open degree adjustment block 205 rotates to a position at which the second contact portion 2052 of the open degree adjustment block 205 faces the stopper portion 13. Because the first contact portion 2051 of the open degree adjustment block 205 makes contact with the bore portion of the door check 21, the door check 201 restricts the open degree adjustment block 205 from moving in the direction of the one end portion of the check link 12 mounted to the vehicle body B. When the door D is opened in a case where the open degree adjustment block 205 is arranged at the aforementioned position, the check link 12 moves in the direction of the one end portion of the check link 12 mounted to the vehicle body B so that the stopper portion 13 makes contact with the second contact portion 2052. Thus, the open degree adjustment block 205 may restrict the movements of the check link 12 and the stopper portion 13 in the direction of the one end portion of the check link 12 mounted to the vehicle body B based on the distance L8 between the first contact portion 2051 and the second contact portion 2052. The open degree adjustment block 205 may therefore restrict the open degree of the door D to the first open degree.

Next a case where the user operates the operation portion to specify the open degree of the door D to the second open degree corresponding to the distance L9 between the first contact portion 2051 and the third contact portion 2053 is explained. In this case, as illustrated in FIG. 22C, the connection member 16 is moved in the lower direction in response to the operation of the operation portion and the open degree adjustment block 205 is rotated in the further lower direction about the first contact portion 2051.

At this time, the open degree adjustment block 205 rotates to a position at which the third contact portion 2053 of the open degree adjustment block 205 faces the stopper portion 13. As mentioned above, because the first contact portion 2051 of the open degree adjustment block 205 makes contact with the bore portion of the door check 201, the door check 201 restricts the open degree adjustment block 205 from moving in the direction of the one end portion of the check link 12 mounted to the vehicle body B. When the door D is opened in a case where the open degree adjustment block 205 is arranged at the aforementioned position, the check link 12 moves in the direction of the one end portion of the check link 12 mounted to the vehicle body B so that the stopper portion 13 makes contact with the third contact portion 2053. Thus, the open degree adjustment block 205 may restrict the movements of the check link 12 and the stopper portion 13 in the direction of the one end portion of the check link 12 mounted to the vehicle body B corresponding to the distance L9 between the first contact portion 2051 and the third contact portion 2053. That is, the open degree adjustment block 205 may restrict the open degree of the door D to the second open degree.

In a case where the open degree of the door D is specified to the first open degree from the second open degree, the open degree adjustment block 205 rotates in the upper direction about the first contact portion 2051 to a position at which the second contact portion 2052 makes contact with the stopper portion 13 in accordance with the movement of the connection member 16. In the same manner, in a case where the open degree of the door D is specified to the full open degree from the first open degree, the open degree adjustment block 205 rotates in the upper direction about the first contact portion 2051 to a position at which the second contact portion 2052 is separated from the check link 12 in accordance with the movement of the connection member 16 and is inhibited from making contact with the stopper portion 13.

Accordingly, in the door check mechanism 200 of the present embodiment, the open degree adjustment block 205 includes the third contact portion 2053 which is opposed to the first contact portion 2051 while including the predetermined distance from the first contact portion 2051 and which is configured to face the stopper portion 13. In addition, the third contact portion 2053 is provided so that the distance L9 between the first contact portion 1051 and the third contact portion 2053 is longer than the distance L8 between the first contact portion 2051 and the second contact portion 2052. The first contact portion 2051 is rotatably connected to the door check 201 and in contact with the bore portion with which the first contact portion 2051 engages at the time being connected to the door check 201. Thus, the contact of the door check 201 with the first contact portion 2051 restricts the movement of the open degree adjustment block 205 in the direction of the one end portion of the check list 12 mounted to the vehicle body B. Thus, when the second contact portion 2052 or the third contact portion 2053 makes contact with the stopper portion 13, the open degree adjustment block 205 restricts the movements of the check list 12 and the stopper portion 13 in the direction of the one end portion of the check list 12 mounted to the vehicle body B. Therefore, the open degree adjustment block 205 may restrict the open degree of the door D in a stepwise manner based on the distance L8 between the first contact portion 2051 and the second contact portion 2052 and the distance L9 between the first contact portion 2051 and the third contact portion 2053. Accordingly, in the door check mechanism 200 of the present embodiment, the open degree of the door D may be restricted in a stepwise manner by the single open degree adjustment block which rotates.

The first contact portion 2051 is connected to the door check 201 at the lateral portion in the portion of the door check 201 through which the check link 12 passes to be positioned. Accordingly, the first contact portion 2051 is configured to face the stopper portion 13. A vector component of impact caused by a contact of the second contact portion 2052 or the third contact portion 2053 with the stopper portion 13 in the rotation direction of the open degree adjustment block 205 may be restrained. As a result, the open degree adjustment block 205 is restrained from rotating in a case where the second contact portion 2052 or the third contact portion 2053 makes contact with the stopper portion 13.

In the door check mechanism 200 according to the present embodiment, the first contact portion 2051 is provided as the protruding portion connected to the bore portion not illustrated provided at the door check 201. At this time, the construction of the first contact portion 2051 is not limited to the above. The first contact portion may be provided as a bore portion to which a protruding portion provided at the door check may be rotatably connected. Even in this case, the first contact portion makes contact with the protruding portion of the door check, so that the door check may restrict the movement of the open degree adjustment block in the direction of the one end portion of the check link 12 mounted to the vehicle body B. The open degree adjustment block is also rotatable about the first contact portion provided as the bore portion. Thus, with the door check mechanism including the aforementioned construction, the open degree of the door D may be restricted in a stepwise manner by the single open degree adjustment block which rotates. The protruding portion may be integrally provided at the door check or the open degree adjustment block, or may be provided by a separate member such as a pin, for example.

The open degree adjustment block 205 includes the two contact portions constituted by the second and third contact portions 2052 and 2053 as the contact portions opposed to the first contact portion 2051 and configured to make contact with the stopper portion 13. At this time, the number of contact portions opposed to the first contact portion 2051 and configured to make contact with the stopper portion 13 is not limited to two. Three or more of such contact portions may be provided. In this case, the open degree adjustment block 205 may restrict the open degree of the door D in a stepwise manner depending on a distance between the first contact portion 2051 and each of the contact portions making contact with the stopper portion 13.

In the door check mechanism 200 according to the present embodiment, the open degree adjustment block 205 rotates in the up-down direction. At this time, the rotation direction of the open degree adjustment block 205 is not limited to the up-down direction. The open degree adjustment block may be at least arranged between the door check 101 and the stopper portion 13 by the rotation. Thus, the open degree adjustment block may be configured to rotate in an arbitrary direction relative to the check link 12. For example, the open degree adjustment block may rotate in the left-right direction relative to the door check 201 in a state where the first contact portion is connected to a top portion and a bottom portion of the door check 201.

The open degree adjustment block 205 may be biased so that the third contact portion 2053 rotates towards the check link 12 by an arbitrary biasing member such as a spring and a rubber member, for example. In this case, because of the aforementioned biasing, the open degree adjustment block 205 is restrained from moving in a direction separating from the check link 12 caused by vibration upon vehicle driving. Thus, even in a case where the second contact portion 2052 or the third contact portion 2053 is inhibited from making contact with the stopper portion 13, looseness or rattle of the open degree adjustment block 205 arranged at a position abutting the check link 12 may be inhibited.

In the above, the present invention is explained with reference to the embodiments; however, the present invention is not limited to the aforementioned embodiments. The invention which is modified within a scope not departing from a principle of the present invention and the invention equivalent to the present invention are also included in the present invention. In addition, the aforementioned embodiments and modified examples may be appropriately combined within a scope not departing from the principle of the present invention.

The present invention is based on and claims priority to Japanese Patent Application 2014-264314, filed on Dec. 26, 2014, and to Japanese Patent Application 2015-151872, filed on Jul. 31, 2015, the entire contents of which are incorporated herein by reference.

### EXPLANATION OF REFERENCE NUMERALS

10, 20, 30, 40, 50, 60, 70, 80, 90, 100, 200: door check mechanism, 11, 21, 31, 41, 71, 101, 201: door check, 12: check link, 13: stopper portion, 14: bracket, 15, 25, 35, 45, 48, 58, 65, 68, 75, 78, 85, 95, 98, 105, 205: open degree adjustment block, 16, 46, 56: connection member, 17, 47: biasing member, 69, 793: link, 79: block base, 111: case portion, 112: base portion, 113, 213, 313, 413, 418: bearing portion, 114, 214, 314, 414, 419, 791: rotary shaft, 115: open portion, 116: pressing element, 117: biasing member, 118: frame portion (solid portion), 119: frame portion abutting portion (solid portion), 121: groove portion, 151, 251, 351, 451, 751, 951, 1051, 2051: first contact portion, 152, 252, 352, 452, 752, 952, 1052, 2052: second contact portion, 153, 154: bore portion, 155, 255, 355: cut portion, 256, 356: connection portion, 481, 781, 981, 1053, 2053: third contact portion, 482, 782, 982: fourth contact portion, 691, 692, 953, 1014, 1015: elongated bore portion, 653, 683, 983, 1054, 1055: protruding portion, 753, 783, 853: arm portion, 792: biasing member, 794, 894: connection portion, 7931, 7932: link contact portion, B: vehicle body, D: door, H: hinge, V: vehicle

1. A door check mechanism comprising:
a movement restricting member configured to be mounted to a door for a vehicle;
a check link including one end portion which is configured to be rotatably mounted to a vehicle body, the check link extending through an inner portion of the door for the vehicle and being relatively movable relative to the movement restricting member in a longitudinal direction of the check link;
a stopper portion provided at the other end portion of the check link which extends through the inner portion of the door for the vehicle; and
an open degree adjustment block rotating relative to the check link,
the open degree adjustment block including a first contact portion configured to make contact with the movement restricting member and a second contact portion opposed to the first contact portion while including a predetermined distance from the first contact portion, the second contact portion being configured to make contact with the stopper portion,
the open degree adjustment block restricting a movement of the check link in a direction of the one end portion of the check link in a case where the open degree adjustment block rotates towards the check link so that the first contact portion makes contact with the movement restricting member and the stopper portion makes contact with the second contact portion.

2. The door check mechanism according to claim 1, where the movement restricting member is a door check.

3. The door check mechanism according to claim 2, wherein the first contact portion includes at least a portion which makes contact with a solid portion of the door check including a predetermined thickness in the longitudinal direction of the check link.

4. The door check mechanism according to claim 1, further comprising another open degree adjustment block rotating relative to the check link, wherein
the another open degree adjustment block includes a third contact portion configured to make contact with the movement restricting member and a fourth contact portion opposed to the third contact portion while including a predetermined distance from the third contact portion, the fourth contact portion being configured to make contact with the stopper portion,
a distance between the third contact portion and the fourth contact portion is longer than a distance between the first contact portion and the second contact portion,
the another open degree adjustment block restricts the movement of the check link in the direction of the one end portion of the check link in a case where the another open degree adjustment block rotates towards the check link so that the third contact portion makes contact with the movement restricting member and the stopper portion makes contact with the fourth contact portion.

5. The door check mechanism according to claim 1, further comprising another open degree adjustment block moving relative to the check link, wherein
the another open degree adjustment block includes a third contact portion configured to make contact with the second contact portion and a fourth contact portion opposed to the third contact portion while including a predetermined distance from the third contact portion, the fourth contact portion being configured to make contact with the stopper portion,
the open degree adjustment block and the another open degree adjustment block restrict the movement of the check link in the direction of the one end portion of the check link in a case where the another open degree adjustment block moves towards the check link so that the third contact portion makes contact with the second contact portion and the stopper portion makes contact with the fourth contact portion.

6. The door check mechanism according to claim 1, wherein
the open degree adjustment block includes:
a third contact portion opposed to the first contact portion while including a predetermined distance from the first contact portion and configured to make contact with the stopper portion; and
a guide portion serving as a rotation center in a case where the open degree adjustment block rotates relative to the check link and guiding a sliding of the open degree adjustment block relative to the check link after the open degree adjustment block rotates towards the check link,
a distance between the first contact portion and the third contact portion is longer than a distance between the first contact portion and the second contact portion,
the open degree adjustment block restricts the movement of the check link in the direction of the one end portion of the check link in a case where the open degree adjustment block slides towards the check link so that the stopper portion makes contact with the third contact portion.

7. The door check mechanism according to claim 1, wherein the open degree adjustment block includes a third contact portion opposed to the first contact portion while including a predetermined distance from the first contact portion and configured to face the stopper portion,
a distance between the first contact portion and the third contact portion is longer than a distance between the first contact portion and the second contact portion,
the first contact portion makes contact with the movement restricting member in a state being rotatably connected to the movement restricting member,
the open degree adjustment block restricts the movement of the check link in the direction of the one end portion of the check link in a case where the open degree adjustment block rotates towards the check link so that the first contact portion makes contact with the movement restricting member and the stopper portion makes contact with the third contact portion.

8. The door check mechanism according to claim 1, wherein the first contact portion includes a cut portion in a vicinity of a rotary shaft of the open degree adjustment block.

9. The door check mechanism according to claim 1, further comprising a biasing member biasing the open degree adjustment block in a direction in which the first contact portion makes contact with the movement restricting member.

10. The door check mechanism according to claim 1, wherein a rotary shaft of the open degree adjustment block is provided extending in a width direction of the door for the vehicle at either one of a top portion and a bottom portion of the movement restricting member.

11. The door check mechanism according to claim 1, wherein a rotary shaft of the open degree adjustment block is positioned at a lateral side of the movement restricting member, the rotary shaft extending in the longitudinal direction of the check link.

12. The door check mechanism according to claim 11, further comprising a biasing member biasing the open degree adjustment block in a direction separating from the movement restricting member in the longitudinal direction of the check link.

13. The door check mechanism according to claim 4, further comprising a coupling member connected to the open degree adjustment block and the another open degree adjustment block to connect the open degree adjustment block and the another open degree adjustment block each other.

14. The door check mechanism according to claim 5, wherein the open degree adjustment block and the another open degree adjustment block include respective connection portions for connecting the open degree adjustment block and the another open degree adjustment block each other.

15. The door check mechanism according to claim 6, wherein the open degree adjustment block includes another guide portion provided at a position away from the guide portion by a predetermined distance to guide rotation and sliding of the open degree adjustment block relative to the check link.
